(19) United States
(12) Patent Application Publication
(10) Pub. No.: US 2026/0054257 A1
(43) Pub. Date: Feb. 26, 2026

(54) MONOLITHIC STRUCTURES AND METHODS OF USE THEREOF

(71) Applicant: ARIZONA BOARD OF REGENTS ON BEHALF OF ARIZONA STATE UNIVERSITY, Scottsdale, AZ (US)

(72) Inventors: Jean Andino, Chandler, AZ (US); Adnan Abdullahi, Rotterdam, NY (US); Mikiye Lamansky, Chandler, AZ (US)

(21) Appl. No.: 19/310,669

(22) Filed: Aug. 26, 2025

Related U.S. Application Data
(60) Provisional application No. 63/687,100, filed on Aug. 26, 2024.

(51) Int. Cl. B01J 27/04; B01D 53/86; B01J 20/18; B01J 20/20; B01J 35/39; B01J 35/56; B01J 35/61; B33Y 10/00; B33Y 70/00; C01B 3/04; C09K 11/02; C09K 11/77

(52) U.S. Cl. CPC B01J 27/04; B01D 53/8612; B01J 20/18; B01J 20/20; B01J 35/39; B01J 35/56; B01J 35/612; B33Y 10/00; B33Y 70/00; C01B 3/04; C09K 11/025; C09K 11/7792; B01D 2255/20761; B01D 2255/20792; B01D 2255/802; B01D 2255/915; B01D 2257/304

(57) ABSTRACT

The disclosure encompasses monolithic compositions, compositions for preparing monolithic compositions, and methods of making and using the same. For example, in non-limiting, exemplary embodiments, the disclosure describes additive manufacturing inks, luminescent monolithic structures produced from said inks, and methods of making and using the same. For example, in some embodiments, the monolithic compositions described herein can perform gas-phase photocatalysis in the absence of light.

This application claims priority to U.S. Provisional Application No. 63/687,100 filed on Aug. 26, 2024, the entire contents of which are incorporated herein by reference.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present invention relates to monolithic structures and methods of making and using the same.

### BACKGROUND OF THE INVENTION

Traditional monolithic contactors have the advantages of good mass transfer and lower pressure drops; however, similar to packed bed and annular (wall-coated) reactors, monoliths are also plagued with low light utilization efficiencies.

### SUMMARY OF THE INVENTION

Aspects of the invention are drawn towards a composition comprising a photocatalyst, a phosphor, a solvent, and a binder, wherein the phosphor comprises an emission profile wavelength that overlaps with the wavelength of the light absorption profile of the photocatalyst. In embodiments, the composition is an additive manufacturing ink. In embodiments, the composition is photoluminescent. In embodiments, the composition comprises a photocatalyst to phosphor ratio of about 1:1 to about 10:1. In embodiments, the photocatalyst is a visible light photocatalyst. In embodiments, the phosphor is a long afterglow phosphor. In embodiments, the binder is a plasticizing organic binder. In embodiments, the solvent comprises H₂O, an alcohol, or a combination thereof. In embodiments, the visible light photocatalyst is ZnS:Cu. In embodiments, the long afterglow phosphor is SrAlO₄:Eu:Dy. In embodiments, the plasticizing organic binder is methyl cellulose. In embodiments, the binder is present in about 2.5 wt. % to about 10.0 wt. %. In embodiments, the wavelength comprises about 380 nm to about 700 nm. In embodiments, the photocatalyst further comprises a sorbent material selective for a gas of interest. In embodiments, the gas of interest can comprise H₂S. In embodiments, the gas of interest can comprise CO₂. In embodiments, the sorbent material can be selected from a zeolite, activated carbon, a metal-organic framework, or a combination thereof. In embodiments, the zeolite can be zeolite 13X, zeolite 5A, or a combination thereof.

Aspects of the disclosure are drawn towards a luminous monolithic structure comprising the composition described herein. In embodiments, the composition described herein can comprise a photocatalyst, a phosphor, a solvent, and a binder, wherein the phosphor comprises an emission profile wavelength that overlaps with the wavelength of the light absorption profile of the photocatalyst. In embodiments, the composition is an additive manufacturing ink. In embodiments, the composition is photoluminescent. In embodiments, the composition comprises a photocatalyst to phosphor ratio of about 1:1 to about 10:1. In embodiments, the photocatalyst is a visible light photocatalyst. In embodiments, the phosphor is a long afterglow phosphor. In embodiments, the binder is a plasticizing organic binder. In embodiments, the solvent comprises H₂O, an alcohol, or a combination thereof. In embodiments, the visible light photocatalyst is ZnS:Cu. In embodiments, the long afterglow phosphor is SrAlO₄:Eu:Dy. In embodiments, the plasticizing organic binder is methyl cellulose. In embodiments, the binder is present in about 2.5 wt. % to about 10.0 wt. %. In embodiments, the wavelength comprises about 380 nm to about 700 nm. In embodiments, the photocatalyst further comprises a sorbent material selective for a gas of interest. In embodiments, the gas of interest can comprise H₂S. In embodiments, the gas of interest can comprise CO₂. In embodiments, the sorbent material can be selected from a zeolite, activated carbon, a metal-organic framework, or a combination thereof. In embodiments, the zeolite can be zeolite 13X, zeolite 5A, or a combination thereof.

Aspects of the disclosure are drawn towards a method of manufacturing a luminous monolithic structure. In embodiments, the method comprises: depositing the composition described herein into a geometry; subjecting the deposited composition to drying, thereby producing a monolithic structure; and exposing the monolithic structure to a sufficient initiation/excitation wavelength, thereby producing a luminous monolithic structure. In embodiments, the composition further comprises a sorbent, thereby producing a dual-function luminous monolithic structure. In embodiments, the sufficient initiation/excitation wavelength comprises about 380 nm to about 700 nm. In embodiments, the composition described herein comprises a photocatalyst, a phosphor, a solvent, and a binder, wherein the phosphor comprises an emission profile wavelength that overlaps with the wavelength of the light absorption profile of the photocatalyst. In embodiments, the composition is an additive manufacturing ink. In embodiments, the composition is photoluminescent. In embodiments, the composition comprises a photocatalyst to phosphor ratio of about 1:1 to about 10:1. In embodiments, the photocatalyst is a visible light photocatalyst. In embodiments, the phosphor is a long afterglow phosphor. In embodiments, the binder is a plasticizing organic binder. In embodiments, the solvent comprises H₂O, an alcohol, or a combination thereof. In embodiments, the visible light photocatalyst is ZnS:Cu. In embodiments, the long afterglow phosphor is SrAlO₄:Eu:Dy. In embodiments, the plasticizing organic binder is methyl cellulose. In embodiments, the binder is present in about 2.5 wt. % to about 10.0 wt. %. In embodiments, the wavelength comprises about 380 nm to about 700 nm. In embodiments, the photocatalyst further comprises a sorbent material selective for a gas of interest. In embodiments, the gas of interest can comprise H₂S. In embodiments, the gas of interest can comprise CO₂. In embodiments, the sorbent material can be selected from a zeolite, activated carbon, a metal-organic framework, or a combination thereof. In embodiments, the zeolite can be zeolite 13X, zeolite 5A, or a combination thereof.

Aspects of the disclosure are drawn towards a luminous monolithic structure produced by a method described herein. In embodiments, the method can comprise depositing the composition described herein into a geometry; subjecting the deposited composition to drying, thereby producing a monolithic structure; and exposing the monolithic structure to a sufficient initiation/excitation wavelength, thereby producing a luminous monolithic structure. In embodiments, the composition further comprises a sorbent, thereby producing a dual-function luminous monolithic structure. In embodiments, the structure comprises photoluminescence. In embodiments, the photoluminescence is sufficient to initiate photocatalysis, sustain photocatalysis, or a combination thereof. In embodiments, the structure exhibits uniform light distribution.

Aspects of the disclosure are drawn towards a dual-functional luminous monolithic structure produced by a method described herein. In embodiments, the method can comprise depositing the composition described herein into a geometry; subjecting the deposited composition to drying, thereby producing a monolithic structure; and exposing the monolithic structure to a sufficient initiation/excitation wavelength, thereby producing a luminous monolithic structure. In embodiments the composition comprises a sorbent, thereby producing a dual-function luminous monolithic structure. In embodiments, the structure comprises photoluminescence. In embodiments, the photoluminescence is sufficient to initiate photocatalysis, sustain photocatalysis, or a combination thereof. In embodiments, the structure exhibits uniform light distribution.

Aspects of the disclosure are drawn towards a method of performing gas-phase photocatalysis. In embodiments, the method can comprise flowing a gas of interest over the surface of the monolithic structure as described herein; and exciting the monolithic structure with a visible light source under the gas flow, thereby performing gas-phase photocatalysis to decompose the gas of interest. In embodiments, the method can further comprise removing the light source, thereby producing an afterglow and performing gas-phase photocatalysis with said afterglow. In embodiments, the gas of interest comprises H₂S. In embodiments, the decomposition of the gas of interest produces H₂.

Other objects and advantages of this invention will become readily apparent from the ensuing description.

### BRIEF DESCRIPTION OF THE FIGURES

The patent or application file contains at least one drawing executed in color. Copies of this patent or patent application publication with color drawing(s) will be provided by the Office upon request and payment of necessary fec.

FIG. 1 shows non-limiting, exemplary schematic of a pneumatic DIW system used in printing the monoliths.

FIG. 2 shows non-limiting, exemplary experimental data. Panels a-d: Luminous response of ZnS:Cu:Bp (sample on the left side of each figure) versus ZnS:Cu (sample on the right side of each figure) before and after being excited by a 385-400 nm LED light source. The images (a-d) cover a 30 s span, starting from t=0 s which represents when the LED excitation source was active. Each time progression after t=0 s represent periods where the LED light source was inactive and hence the afterglow of the prints. The times are labelled in the figure.

FIG. 3 shows non-limiting, exemplary ZnS:Cu:Bp print post-excitation by a 385-400 nm LED light source. Channels within the monolith also exhibit luminosity.

FIG. 4 shows non-limiting, exemplary viscosity shear rate behavior of ZnS:Cu vs ZnS:Cu:Bp inks showing expected viscoelastic profile typified by shear thinning.

FIG. 5 shows a non-limiting, exemplary rheological profile of ZnS:Cu vs ZnS:Cu:Bp showing random behavior at higher shear rates.

FIG. 6 shows a non-limiting, exemplary SEM image of ZnS:Cu at 1000× magnification showing sub 4 μm particle sizes and agglomeration of particles.

FIG. 7 shows a non-limiting, exemplary SEM image of SrAlO₄:Eu:Dy (Bp) phosphor at 100× magnification.

FIG. 8 shows a non-limiting, exemplary SEM image of ZnS:Cu:Bp at 1500× magnification.

FIG. 9 shows a non-limiting, exemplary EDS analysis of 3D printed ZnS:Cu showing compositional analysis region of ZnS:Cu specimen and elemental peak intensity plot of ZnS:Cu specimen with well-established peaks of Zn and S.

FIG. 10 shows a non-limiting, exemplary EDS analysis of the phosphor showing compositional analysis region of and elemental peak intensity plot of the phosphor specimen with rare metals present in the composite.

FIG. 11 shows a non-limiting, exemplary EDS analysis of 3D printed ZnS:Cu:Bp showing compositional analysis region of ZnS:Cu:Bp specimen and elemental peak intensity plot of ZnS:Cu:Bp specimen with an array of elements present in the composite.

FIG. 12 shows N₂ Adsorption isotherms of 3D printed ZnS:Cu and ZnS:Cu:Bp showing type II behavior with H₃ hysteresis.

FIG. 13 shows non-limiting, exemplary differential pore volume distribution of 3D printed ZnS:Cu:Bp and ZnS:Cu showing transition in porosity due to incorporation of the phosphor.

FIG. 14 shows a non-limiting, exemplary reflectivity profile of ZnS:Cu compared ZnS:Cu:Bp.

FIG. 15 shows non-limiting, exemplary absorption and emission profiles of (panel a) ZnS:Cu and (panel b) the phosphor, as well as (panel c) ZnS:Cu absorption and the blue phosphor emission showing a clear overlap.

FIG. 16 shows non-limiting, exemplary absorption and emission profiles of ZnS:Cu:Bp composites showing a double peak in its emission profile.

FIG. 17 shows non-limiting, exemplary photoluminescence time intensity of ZnS:Cu:Bp showing strong but rapidly decaying intensity at start of the PL profile followed by a stable fixed intensity value.

FIG. 18 shows non-limiting, exemplary FTIR spectra of ZnS:Cu vs ZnS showing distinct differences in the spectra.

FIG. 19 shows a non-limiting, exemplary experimental schematic of setup used for photocatalytic testing showing interconnected lines from the gas generator to the reactor and then the MX6 sensor. Thick directional arrows indicate gas flow to reactor, while dashed arrows indicate gas flow to bypass line.

FIG. 20 shows non-limiting, exemplary N₂ Adsorption isotherms of 3D printed ZnS:Cu, ZnS:Cu:Zeo and ZnS:Cu:AC.

FIG. 21 shows non-limiting, exemplary N₂ Adsorption isotherms of 3D printed ZnS:Cu:Bp, ZnS:Cu:Zeo:Bp and ZnS:Cu:AC:Bp.

FIG. 22 shows a non-limiting, representative reflectivity profile of ZnS:Cu and its composite variations incorporating adsorbents, phosphor or a combination of both.

FIG. 23 shows a non-limiting, representative absorbance and relative emission profile of ZnS:Cu:Bp and ZnS:Cu:Zeo:Bp composites showing significant intersection.

FIG. 24 shows non-limiting, exemplary experimental data. (Panel a) Array of printed structures in ambient lighting-From Top left corner ZnS:Cu:Zeo:Bp, ZnSCu:AC, ZnS:Cu:Zeo From bottom left corner ZnS:Cu, ZnSCu:AC:Bp, ZnSCu:Bp (Panel b) Array of printed structure at time 0 after UV light source is turned off (Panel c) Array of printed structure at time 2 mins after UV light source is turned off. (Panel d) ZnS:Cu:Bp loaded into photocatalytic reactor and excited by a LED lamp source.

FIG. 25 shows non-limiting, exemplary photoluminescence time intensity of ZnS:Cu:Bp vs ZnS:Cu:Zeo:Bp showing strong but rapidly decaying intensity at the start of the PL profile followed by a stable fixed intensity value.

FIG. 26 shows non-limiting, exemplary dark adsorption breakthrough curve comparison between ZnS:Cu, ZnS:Cu:Zeo and ZnS:Cu:AC, showing extended adsorbent composite delayed breakthrough.

FIG. 27 shows non-limiting, exemplary dark adsorption plot comparisons between phosphor based and non-phosphor-based prints.

FIG. 28 shows non-limiting, exemplary photocatalytic activity of ZnS:Cu sample vs ZnS:Cu:Bp sample showing extended conversion for phosphor-based sample as against base ZnS:Cu.

FIG. 29 shows non-limiting, exemplary photocatalytic activity of ZnSCu:Zeo:Bp sample vs ZnS:Cu:Zeo sample showing defined extended conversion for phosphor-based sample.

FIG. 30 shows a non-limiting, exemplary long term destruction behavior of ZnS:Cu:AC vs Zns:Cu:AC:Bp.

FIG. 31 shows non-limiting, exemplary cyclic response of ZnS:Cu:Bp at intervals of 20 mins showing limited H₂S conversion in the dark.

FIG. 32 shows non-limiting, exemplary cyclic response of ZnS:Cu:AC:Bp showing similar profile as base ZnS:Cu:AC with no afterglow H₂S conversion detected.

FIG. 33 shows non-limiting, exemplary cyclic response of ZnS:Cu:Zeo:Bp and its non-phosphor counterpart. ZnS:Cu:Zeo:Bp is run in long and short adsorption modes.

FIG. 34 shows a non-limiting, exemplary rheological profile of non-phosphor-based inks showing pseudoplastic behavior and departure from pseudoplasticity at high shear rates.

FIG. 35 shows a non-limiting, exemplary rheological profile of phosphor-based inks showing pseudoplastic behavior and departure from pseudoplasticity at high shear rates.

FIG. 36 shows non-limiting, exemplary SEM images at 1000X (panel a) 3D printed ZnS:Cu (panel b) 3D printed ZnS:Cu:Zeo and (panel c) 3D printed ZnS:Cu:AC.

FIG. 37 shows a non-limiting, exemplary SEM image of SrAlO₄:Eu:Dy(Bp) phosphor showing a close network of phosphor at 100× magnification. The phosphor particles are at least 3 times larger than the ZnS:Cu.

FIG. 38 shows non-limiting, exemplary scattered electron images of (panel a) 3D printed ZnS:Cu:Bp (panel b) 3D printed ZnS:Cu:Zeo:Bp and (panel c) ZnS:Cu:AC:Bp all showing particle dispersion.

FIG. 39 shows non-limiting, exemplary differential pore volume distribution of 3D printed ZnS:Cu, ZnS:Cu:Zeo and ZnS:Cu:AC.

FIG. 40 shows non-limiting, exemplary differential pore volume distribution of 3D printed ZnS:Cu:Bp, ZnS:Cu:Zeo:Bp and ZnS:Cu:AC:Bp.

FIG. 41 shows non-limiting, exemplary afterglow of stacked ZnS:Cu:Zeo:Bp prints.

FIG. 42 shows non-limiting, representative afterglow of SrAlO₄:Eu:Dy molded into a tablet with the aid of methylcellulose binder.

FIG. 43 shows non-limiting, exemplary experimental data. (Panel A) shows BSE image of SrAlO₄:Eu:Dy sample showing spots analyzed via EDS. (Panel B) shows EDS composition of SrAlO₄:Eu:Dy showing elemental composition of selected spots.

FIG. 44 shows non-limiting, exemplary experimental data. (Panel A) shows non-limiting, representative BSE image of ZnS:Cu:AC sample showing spots analyzed via EDS. (Panel B) shows EDS composition of ZnS:Cu:AC showing elemental composition of selected spots.

FIG. 45 shows non-limiting, exemplary experimental data. (Panel A) shows BSE image of ZnS:Cu:AC:Bp sample showing spots analyzed via EDS. (Panel B) shows EDS composition of ZnS:Cu:AC:Bp showing elemental composition of selected spots. (Panel C) shows BSE image of ZnS:Cu:Zeo sample showing spots analyzed via EDS. (Panel D) shows EDS composition of ZnS:Cu:Zeo showing elemental composition of selected spots.

FIG. 46 shows non-limiting, exemplary data. (Panel A) shows BSE image of ZnS:Cu:Zeo:Bp sample showing spots analyzed via EDS. (Panel B) shows EDS composition of ZnS:Cu:Zeo:Bp showing elemental composition of selected spots.

### DETAILED DESCRIPTION OF THE INVENTION

Detailed descriptions of one or more embodiments are provided herein. It is to be understood, however, that the invention can be embodied in various forms. Therefore, specific details disclosed herein are not to be interpreted as limiting, but rather as a basis for the claims and as a representative basis for teaching one skilled in the art to employ the invention in any appropriate manner.

The singular forms “a”, “an” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower). In embodiments, the term “about” can be denoted by “˜”.

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more desired result(s).

Before explaining at least one embodiment of the disclosure in detail, it is to be understood that the disclosure is not necessarily limited in its application to the details set forth in the following description or exemplified by the examples. The disclosure can be used for other embodiments or of being practiced or carried out in various ways. Other compositions, compounds, methods, features, and advantages of the disclosure will be or become apparent to one having ordinary skill in the art upon examination of the following drawings, detailed description, and examples. All such additional compositions, compounds, methods, features, and advantages can be included within this description, and be within the scope of the disclosure.

Aspects of the disclosure are drawn towards a composition comprising a photocatalyst, a phosphor, a solvent, and binder. In embodiments the wavelength of the emission profile of the phosphor overlaps with the wavelength of the light absorption profile of the photocatalyst.

In embodiments, the photocatalyst and the phosphor can be any photocatalyst-phosphor pair wherein the emission profile of the phosphor overlaps with the wavelength of the light absorption profile of the photocatalyst.

In embodiments, the photocatalyst can be a low band gap photocatalyst. As used herein, the phrase “low band gap photocatalyst” can refer to a photocatalyst with a band gap that is low enough for an electron of the valence band to be excited by a low energy source into the conduction band. For example, the low energy source can be visible light.

For example, a low band gap can refer to a bad gap of about less than about 0.1 eV, about 0.2 eV, about 0.3 eV, about 0.4 eV, about 0.5 eV, about 0.6 eV, about 0.7 eV, about 0.8 eV, about 0.9 eV, about 1.0 eV, about 1.1 eV, about 1.2 eV, about 1.3 eV, about 1.4 eV, about 1.5 eV, about 1.6 eV, about 1.7 eV, about 1.8 eV, about 1.9 eV, about 2.0 eV, about 2.1 eV, about 2.2 eV, about 2.3 eV, about 2.4 eV, about 2.5 eV, about 2.6 eV, about 2.7 eV, about 2.8 eV, about 2.9 eV, or greater than about 3.0 eV.

As used herein, the phrases “low band gap photocatalyst” and “visible light photocatalyst” can be used interchangeably. For example, the photocatalyst can be selected from any visible light photocatalyst known in the art. For example, the photocatalyst can be an n-type or p-type semiconductor.

In some embodiments, the photocatalyst can have a wide bandgap that is modulated by the incorporation of a dopant. For example, the dopant can shorten the bandgap. For example, the dopant can be a metal dopant or a non-metal dopant. Non-limiting, exemplary non-metal dopants can be nitrogen, sulfur, carbon, phosphorus, or a combination thereof. Non-limiting, exemplary metal dopants can be Ag, Mg, Cu, Rb, Co, Mo, Au, Pt, Fe, Cr, V, Eu, Dy, or a combination thereof.

For example, the photocatalyst can be selected from, but is not limited to, the group consisting of ZnS:Cu, titanium dioxide (TiO₂) dopants, cadmium sulfide (CdS), zinc oxide (ZnO), zinc sulfide (ZnS), (CdS+ZnS)/Fe₂O₃, CuGa_{1.6}Fe_{0.4}O₂, metal-organic framework (MOF) compounds, carbon nitride g-C₃N₄, bismuth oxyhalides (e.g., BiOCl, BiOBr, BiOI), black phosphorus (BP), ZnFe₂O₄, graphene oxide (GO), copper oxide (Cu₂O), molybdenum sulfide (MoS₂), or a combination thereof.

In embodiments, the phosphor can be a long afterglow phosphor. As used herein, the phrase “long afterglow phosphor” can refer to a luminescent material that produces extended illumination post light excitation due to the trapping and subsequent releasing of holes and electrons. For example, the long afterglow phosphor can be SrAlO₄ or SrAlO₄ doped with europium (Eu) and/or dysprosium (Dy). For example, the phosphor can be SrAlO₄:Eu:Dy. In embodiments, the phosphor can be CaAl₂O₄ or CaAl₂O₄ doped with Eu, Nd or a combination thereof. In embodiments, the phosphor can be SrGa₂O₄ or SrGa₂O₄ doped with Cu.

In embodiments, there can be more active catalyst than phosphor in the monolith. For example, the catalyst:phosphor mass ratio (i.e., loading) can comprise about 1:1 to about 10:1. For example, the photocatalyst:phosphor mass ratio can comprise about 1:1, about 2:1, about 3:1, about 4:1, about 5:1, about 6:1, about 7:1, about 8:1, about 9:1, about 10:1, or greater than about 10:1.

In embodiments, the photocatalyst:phosphor mass ratio can be about 1:0.99, about 1:0.95, about 1:0.9, about 1:0.85, about 1:0.8, about 1:0.75, about 1:0.7, about 1:0.65, about 1:0.6, about 1:0.55, about 1:0.5, about 1:0.45, about 1:0.4, about 1:0.35, about 1:0.3, about 1:0.25, about 1:0.2, about 1:0.15, about 1:0.1, about 1:0.05, or less than about 1:0.05.

In embodiments, the ink can behave viscoelastically. In embodiments, the photocatalyst can form a viscoelastic ink.

In embodiments, the composition comprises a binder that does not shift the optical properties of the catalyst and phosphor such that they are no longer compatible. For example, the binder can be a plasticizing organic binder. For example, the plasticizing organic binder can be an epoxy resin, a polysaccharide, a natural resin, or a polymeric plasticizer. For example, the polysaccharide can comprise cellulose derivatives. For example, the cellulose derivatives can comprise methylcellulose and carboxymethylcellulose. (Sec, e.g., U.S. Pat. No. 11,298,675). For example, the polymeric plasticizer can comprise polyethylene glycol (PEG) and polypropylene glycol (PPG).

In embodiments, the binder does not comprise a co-binder. In embodiments, the binder does not comprise a clay binder. In embodiments, the binder does not comprise polylactic acid (PLA).

In embodiments, the binder can be present in an amount sufficient to provide structural integrity for the additive manufacturing. For example, the wt. % of the binder and the wt. % of the catalytic ingredients can be balanced.

In embodiments, the binder is present in about 0.01 wt. % to about 10.0 wt. %. For example, the binder is present in less than about 0.01 wt. %, about 0.01 wt. %, about 0.1 wt. %, about 0.25 wt. %, about 0.5 wt. %, about 0.75 wt. %, about 1.0 wt. %, about 1.25 wt. %, about 1.5 wt. %, about 1.75 wt. %, about 2.0 wt. %, about 2.25 wt. %, about 2.5 wt. %, about 2.75 wt. %, about 3.0 wt. %, about 3.25 wt. %, about 3.5 wt. %, about 3.75 wt. %, about 4.0 wt. %, about 4.25 wt. % about 4.5 wt. %, about 4.75 wt. %, about 5.0 wt. %, about 5.5 wt. %, about 6.0 wt. %, about 7.0 wt. %, about 8.0 wt. %, about 9.0 wt. %, about 10.0 wt. %, or greater than about 10.0 wt. %. In some embodiments, the binder is present in about 2.5 wt. % to about 5.0 wt. %. In some embodiments, the binder is present in at least about 4.5 wt. % and no more than about 5.5 wt. %.

In embodiments, the composition further comprises a sorbent material. The sorbent material can be selected based upon its adsorption selectivity for the target gas of interest. As used herein, the term “target gas of interest” or “target gas” can refer to the gas to undergo photocatalysis. For example, the target gas of interest can comprise a gaseous pollutant. For example, the target gas of interest, or target gas can be H₂S, CO₂, or a combination thereof. In some embodiments, the target gas is H₂S.

In some embodiments, the target gas is not a pollutant. In some embodiments, the sorbent material can show selectivity for the target gas. Non-limiting, exemplary sorbents can be selected from the group consisting of activated carbon, a zeolite, a metal-organic framework, or a combination thereof. For example, the zeolite can be zeolite 13X, zeolite 5A, or a combination thereof. For example, activated carbon and zeolites can be selective for H₂S. For example, zeolite materials can be selective for CO₂.

In embodiments, the composition described herein can be an additive manufacturing ink.

In embodiments, the composition comprises a suitable solvent. This solvent can be selected based upon solubilities and determined by one of ordinary skill in the art. For example, the solvent can comprise H₂O or an alcohol. For example, the alcohol can be selected from the group consisting of methanol, ethanol, butanol, propanol, hexanol, neopentyl alcohol, or a combination thereof. In embodiments, the solvent can be an organic solvent.

In embodiments, the wavelength of the emission profile of the phosphor and the wavelength of the light absorption profile of the photocatalyst can comprise about 380 nm to about 700 nm. For example, the wavelength of the emission profile of the phosphor and the wavelength of the light absorption profile of the photocatalyst can comprise less than about 380 nm, about 380 nm, about 390 nm, about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, about 700 nm, about 710 nm, about 720 nm, about 730 nm, about 740 nm, about 750 nm, about 760 nm, about 770 nm, about 780 nm, about 790 nm, about 800 nm, or greater than about 800 nm.

Aspects of the disclosure are drawn towards a method of manufacturing a luminous monolithic structure. In embodiments, the method comprising: depositing a composition comprising a photocatalyst, a phosphor, a solvent, and binder, wherein the wavelength of the emission profile of the phosphor overlaps with the wavelength of the light absorption profile of the photocatalyst; subjecting the deposited ink to drying, thereby producing a monolithic structure that is luminescent. In embodiments, the monolithic structure be exposed to a sufficient initiation/excitation wavelength, thereby producing a luminous monolithic structure. For example, luminosity can be observed under dark conditions when the light source is no longer present.

In embodiments, the geometry can be any geometry known in the art. For example the geometry can be any geometry produced by any DIW process as known in the art. For example, the geometry can be any geometry achieved by using a template and filling said template with a luminous composition as described herein. For example, the geometry can be circular or square.

As used herein, the term “monolith” can refer to a solid, three-dimensional structure that is not particulate in nature. In some embodiments, the monolith can comprise channels. In embodiments, the channels can be gas flow paths. Herein, the terms “monolith” and “monolithic” can be used interchangeably. For example, as compared to their pellet and powder form counterpart, monoliths offer the benefits of improved mass transfer, lower pressure drop, higher surface area per unit volume and considerable mechanical strength.

As used herein, the term “luminous” and “luminescent” can be used interchangeably and can refer to the property of reflecting or emitting light from a surface. For example, the structures described herein can emit light in the dark after having been excited by a light source. The wavelength of light emitted can be dependent on the optical properties of the phosphor within the monolith.

In embodiments, the ink further comprises a sorbent, thereby producing a dual-function luminous monolithic structure. In embodiments, the sorbent can be incorporated at the ink preparation stage. In embodiments, the sorbent can be mixed with the catalyst, the phosphor, the binder and the solvent to form a viscoelastic solution.

In embodiments, the sufficient initiation/excitation wavelength comprises about 380 nm to about 700 nm. As used herein, the term “initiation/excitation wavelength” can refer to electromagnetic energy having a wavelength shorter than or equal to (i.e., equal or higher energy) than the absorption wavelength range of the species to be excited. This wavelength can be recognized by those of ordinary skill in the art.

Aspects of the disclosure are drawn towards a monolithic structure produced by a method described herein. In embodiments, the structure comprises photoluminescence. In embodiments, the photoluminescence is sufficient to initiate and/or sustain photocatalysis. In embodiments, the structure exhibits uniform light distribution. For example, the uniform light distribution can be within the channels of the structure.

Aspects of the invention are drawn towards a dual-function luminous monolithic structure produced by a method described herein. As used herein, the term “dual-function” can refer to a material possessing both luminosity and the ability to act as a sorbent. In embodiments, the structure is photoluminescent. In embodiments, the structure exhibits uniform light distribution. For example, the uniform light distribution can be within the channels of the structure.

In embodiments, the structures described herein can perform gas-phase photocatalysis on a target gas. As used herein, the terms “target gas” and “gas of interest” can be used interchangeably. For example, the gas-phase photocatalysis can be used for air purification, environmental remediation, or gas conversion. For example, structures described herein can be used to remove and/or convert volatile organic compounds (VOCs) and nitrogen oxides (NOx). For example, the VOC can comprise hydrogen sulfide (H₂S). For example, the structures described herein can be used to convert gases into other chemicals to be used for other applications.

As used herein, the terms “target gas” and “gas of interest” can be used interchangeably. As used herein, the term “target gas” can refer to a gas to be subject to photocatalysis. For example, the target gas can comprise CO₂, H₂S, N₂O, or NO.

Aspects of the disclosure are drawn towards a method of performing gas-phase photocatalysis comprising: flowing a target gas over the surface of a monolithic structure described herein; and exciting the monolithic structure with a visible light source under the gas flow, thereby performing gas-phase photocatalysis to decompose the gas of interest.

In embodiments, the surface of the monolithic structure can be the channels of the structure. For example, the photocatalysis can be performed in a reactor system allowing for visible light penetration and the flow of the gas of interest through the reactor. For example, the printed luminous monolith can be positioned within the reactor system in a manner that allows gas flowing into the reactor to pass through the monolith's channels. A visible light source can excite the luminous monolith under the gas flow and allow for decomposition/conversion of the target gas. When the light source is removed, the luminous monolith can still exhibit luminosity to sustain gas splitting/conversion.

In embodiments, the gas of interest can comprise CO₂, H₂S, N₂O, or NO. In embodiments, the gas of interest can comprise H₂S. In embodiments, the decomposition of the gas of interest can produce H₂.

### EXAMPLES

Examples are provided herein to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

### Photocatalytic Luminous Monoliths

Described herein is a photocatalytic material that can extend the catalytic process even after exposure to an external light source is removed. The added materials are luminous in nature, and therefore enable extended operation. The direct ink written nature of the material enables the material to be constructed in different forms. The disclosure relates to the field of sustainable catalytic systems for the removal of air pollutants. The direct ink written material was developed to provide a material that can not only adsorb gaseous pollutants but convert these pollutants to other gases (even useful gases) and do so with lowered energy needs by creating a material that can internally maintain the light driven catalytic activity.

Non-limiting features described herein comprise a new catalyst material and luminous material mixed with a binder; catalytic and luminous material mixtures that can be 3D printed; a structure that utilizes light to initiate chemistry; structures that maintain an afterglow within the structure once the external light is turned off and the light of afterglow can have energy sufficient to initiate chemistry; structures that when exposed to a pollutant of interest can adsorb said pollutant; and structures that enable conversion of an adsorbed pollutant during direct external light activation as well as in the afterglow light period. For example, two non-limiting exciting aspects described herein comprise the direct ink writing of the material to generate photocatalytic luminous structures of any configuration and the extended activity of the material due to the luminous nature of the material that creates and the afterglow activity.

Non-limiting advantages described herein comprise the ability to create structures in different form factors. This can enhance the use of the structure in different applications. Moreover, the luminous effect of the material can lower the energy demand of the photocatalytic material and allow for greater light penetration to the structure, thereby allowing more of the chemical surface to be activated.

For example, described herein are luminous monolithic structures for photocatalytic applications. Traditional monolithic contactors have the advantages of good mass transfer and lower pressure drops; however, similar to packed bed and annular (wall-coated) reactors, monoliths are also plagued with low light utilization efficiencies. Multifunctional luminous monoliths for photocatalytic applications based on the ZnS:Cu structure incorporated with SrAlO₄:Eu:Dy blue phosphor (Bp) were printed using Direct Ink Writing (DIW) in order to achieve intrinsic illumination of monoliths even after an external light source was terminated.

The structures can be used for sustainable catalytic systems for the removal of air pollutants. The direct ink written material was developed in order to provide a material that can not only adsorb gaseous pollutants but convert these pollutants to other gases (even useful gases), and do so with lowered energy needs by creating a material that can internally maintain the light driven catalytic activity. For example, described herein is a ZnS:Cu structure incorporated with SrAlO₄:Eu:Dy blue phosphor (Bp) with methyl cellulose binder was printed using Direct Ink Writing (DIW). The structure maintains an afterglow once the external light is turned off. The light of the afterglow is of sufficient energy to initiate chemistry.

### Example 2

### Direct Ink Written ZnS:Cu Photocatalytic Luminous Monoliths

Traditional monolithic contactors have the advantages of good mass transfer and lower pressure drops; however, similar to packed bed and annular (wall-coated) reactors, monoliths are also plagued with low light utilization efficiencies. Multifunctional luminous monoliths for photocatalytic applications were printed using a Direct Ink Writing (DIW) approach in order to achieve intrinsic illumination of monoliths even after an external light source was terminated. A ZnS:Cu-based monolith incorporated with SrAlO₄:Eu:Dy blue phosphor (Bp), that emitted light in the absorption range of ZnS:Cu was developed. Results demonstrated that the printed monoliths maintained the absorption profile of the base ZnS:Cu catalyst, exhibited whole structure luminescence, and showed a multipeak photoluminescence profile post excitation, that was representative of the peaks of the phosphor and ZnS:Cu. Additionally, the ZnS:Cu:Bp print exhibited steady illumination for up to 30 min. DIW guidelines were developed for the fabrication of afterglow monoliths, and a route to ameliorate the light distribution challenge of monolithic systems was achieved due to the whole luminescence that was displayed by the prints. Although this disclosure describes starting semiconductor (ZnS:Cu), the methods are applicable to different materials that form printable inks.

### Introduction

As the library of materials compatible with Additive Manufacturing (AM)/three-dimensional (3D) printing has expanded, the technology has found growing applicability and adoption in fields such as catalysis and adsorption [1-3]. Alongside the expanding materials library, new printing techniques compatible with these materials have also emerged. Direct Ink Writing (DIW) is a technique that allows the printing of inks formed from powder-based catalysts/adsorbents into pre-defined 3D shapes and forms. AM's unique features such as flexibility in design and the ability to manufacture geometries that would otherwise be impossible to attain using conventional manufacturing methods has increased the interest of researchers in the environmental and renewable energy field. Researchers have leveraged these features alongside the ever-expanding library of materials capable of being printed (even with low-cost desktop 3D printers) to the design of monoliths for gas separation applications and for energy generation and storage [1,4-6].

Semiconducting materials, including ZnS, have been included in the AM wave. ZnS is a semiconductor that has luminescent properties, tailored by the combination of different dopants [7-9]. For example, printing of ZnS and its copper doped variation (ZnS:Cu). ZnS based phosphors respond to an array of stimuli to give a tunable optical response typified by a repeatable glow [10-12]. The applications of this class of materials vary from display applications [13,14] to applications such as stress monitoring on structures [15].

Different approaches to attaining functional 3D prints of ZnS doped with copper (ZnS:Cu) phosphors have been explored [10,11]. For example, 3D-printed alternating current driven electroluminescent devices have been made of ZnS:Cu encased within a polylactic acid (PLA) matrix. [10] The PLA matrix allowed for case of printing of the phosphor via the 3D-printing fused deposition modeling approach. The printed PLA-phosphor composite was sandwiched between an indium tin oxide (ITO) substrate and a conductive PLA electrode, and tunable luminescence was observed upon altering supply voltage and frequency. Direct ink writing of mechano-luminescent (ML) materials capable of energy harvesting in the dark under an applied mechanical strain has also been studied. [11] The ink developed consisted of metal doped ZnS, poly dimethyl siloxane (PDMS) and a platinum-based curing retarder which allowed for long opening time of the ink developed. Additionally, the extruder head for printing was cooled externally using an ice-salt mixture at 0-5° C. to further improve opening time and facilitate printing. Wind driven structures that exhibited an optical response under mechanical strain have also been produced. The wind driven ML structures were paired with a perovskite solar cell to harness the light generated by the former for power production by the perovskite solar cells.

Beyond its luminescent characteristics, ZnS:Cu can also have photocatalytic activity of [16-23]. ZnS:Cu is attractive as a photocatalyst due to its extended absorption in the visible light range as a result of its Cu doping [24]. Three-dimensional printing methods geared towards utilizing the mechano-luminescence or electroluminescence of ZnS:Cu required a stress transfer or conductive matrix, respectively. Thus, additives like PDMS or auxiliary materials like conductive PLA and ITO electrodes that enabled the formation of flexible or conductive phosphor-based structures respectively were needed. In prior studies, the 3D printing of ZnS:Cu employing fused deposition modelling (FDM) required PLA to facilitate printing or a platinum curing retarder and extruder cooling mechanism to facilitate printing of its PDMS-phosphor ink via DIW. Patel et al. [11] utilized a 7:3 by mass active ZnS:Cu to PDMS ratio and 1 wt % platinum curing retarder, while Brubaker et al. utilized a maximum of 40% ZnS:Cu in PLA. However, for photocatalytic applications, the ZnS:Cu ink can consist of a high catalyst loading with minimal external elements (i.e., non catalytic material) that can interfere with the desired photocatalytic reaction.

As compared to their pellet and powder form counterpart, monoliths offer the benefits of improved mass transfer, lower pressure drop, higher surface area per unit volume and mechanical strength [25-27]. Monolithic structures have been used in varying photocatalytic applications [28-31]. Despite the inherent benefits of monolithic reactors as regards to pressure drop and surface to volume ratio, the efficiency of a monolithic structure was hindered due to limited light penetration through the cells/channels of the system. To circumvent this, Lin et al. proposed the use of optical fibers in tandem with ceramic honeycomb monoliths. The fibers served as a light transmitting conductor and radiated light within the channels of the monolith while also serving additionally as support for the TiO₂ photocatalyst that was employed. Lin et al. reported much greater apparent quantum efficiency for their proposed reactor configuration as compared to a baseline annular reactor. Other studies also investigated both numerically and experimentally—the optical fiber monolith reactor configuration [33-37] and found success tackling pollutants such as CO₂ and α-Pinene.

Despite the efficiency enhancements that were noted for selected systems with the fiber optic cable monolith reactor configuration, this type of system poses intrinsic challenges. One of the most prominent challenges is that it is not ideal for applications where a great deal of catalyst mass is required to drive conversion. For said applications, monoliths can be fashioned in a bulk manner, consisting fully of the catalyst material, as against the catalyst being coated only in the channels of a monolith made of support material [38]. Fiber optic illumination in this case of bulk monoliths cannot reach the micropore and mesopore levels where gas species can be present. Additionally, [39] lengths beyond 10 cm, ˜60% loss in light intensity even without catalyst coating on the fiber was observed in optical fiber cables used [39]; this loss in signal was also observed in other studies [40-42].

An alternative to the fiber optic cable-monolith reactor is a bulk monolith with the ability to internally generate its own light of desired wavelength post termination of illumination by a traditional light source. When compared to the fiber optic cable-monolith system, an opportunity presents to have a desired light source present beyond not only in the channels of the monolith, but at the nanoscale levels of the monolith as well. One way to achieve this using ZnS:Cu without a stress activation or a conductive medium requires incorporating an afterglow phosphor capable of emitting light in the absorption range of ZnS:Cu. SrAlO₄:Eu:Dy blue phosphor is one such afterglow phosphor that emits light in the absorption range of ZnS:Cu. Phosphor-photocatalysts composites have been explored [43-47]. However, an additive manufacturing approach by direct ink writing to create these composites has yet to be explored, especially with ZnS:Cu as the photocatalyst of choice.

Described herein is the direct ink writing of ZnS:Cu luminous monolith structures that can be used for photocatalytic applications. The monolith structures were 3D printed from ZnS:Cu mixed with a long afterglow phosphor doped with europium and dysprosium and methylcellulose serving as a binder. The structures not only serve as an active catalyst in the absence of a lamp source, but also as an alternative approach to ameliorate the light attenuation problem that fiber optic monolith systems face. The choice of photocatalyst (ZnS:Cu) and phosphor (SrAlO₄:Eu:Dy) was based on the compatible emission profile of the phosphor and the light absorption profile of the photocatalyst. Additionally, the binder selected (methylcellulose) for facilitating ink production for the DIW process was motivated by the need to achieve low binder content utilization. A variation of methylcellulose can be a non-toxic thickener that does not interfere with the absorption or emission of light [5]. The work that is presented here contributes to the field by highlighting a new, unique monolith-based material for photocatalytic applications. Additionally, the natural operation of luminous monolithic prints is a direct contribution to the ongoing work of developing continuously operable photocatalytic systems. From a commercial perspective, such photocatalytic systems can, without wishing to be bound by theory, provide continual degradation of pollutant or product generation (once optimized for a particular process) without the need for a continuously powered light source. This can lead to energy and financial savings, as no additional energy would be required to excite the monoliths beyond what would already be available initially for photocatalysis.

### Experimental Section

### Materials

Fine powder ZnS:Cu (Cu<1 wt %) was used as received from Phosphor Technology LTD (United Kingdom) with reported particle size less than 10 μm. Methyl cellulose (MC) from Sigma-Aldrich Inc with a viscosity of 400 cP was used as a binder, without further modifications. Custom manufactured SrAlO₄ blue phosphor doped with Eu and Dy (SrAlO₄:Eu:Dy) was obtained from PhosphorTech Corporation (Kennesaw, Georgia) and used as received. In addition to the chemicals, modifications had to be made to the 3D printer (as described subsequently) in order to enable direct ink writing. Syringes (5 cc from Nordson EFD) and corresponding piston and air delivery fixtures formed an integral part of the 3D printing system. A 9-W black lamp LED bulb producing light in the 385-400 nm wavelength was also employed to excite the 3D printed samples for visual observation of their luminosity.

### Direct Ink Writing of Materials

Two ink types were developed for this study: (1) an ink with just ZnS:Cu and binder present and (2) a variation which had SrAlO₄:Eu:Dy blue phosphor, ZnS:Cu, and binder. In both cases, a 5 wt. % binder content was used while ZnS:Cu catalyst and SrAlO₄:Eu:Dy blue phosphor made up the remaining constituents as needed. Mixing of the resultant powder mix proceeded at low speeds of 400 rpm initially as de-ionized water was added into the mixture 1-2 mL at a time. Mixing speed was increased to 1200 rpm after a slurry was formed and regions of dry powder were no longer visible in the mixing vessel. The low speed that was initially employed promoted a uniform dispersion of powders. At the increased speed of 1200 rpm the ink was allowed to mix for 90 min with dropwise water addition, ensuring that the total water used for the ink batch did not exceed 10 mL for a total of 10 g of powder being mixed.

Post mixing, successful inks had consistencies that were visually and texturally similar to popular pseudoplastic fluids, e.g. toothpaste. Additionally, it was observed over multiple trials that inks that led to successful 3D prints were extrudable at pressures of 10-15 psig (68.95 kPa-103.42 kPa).

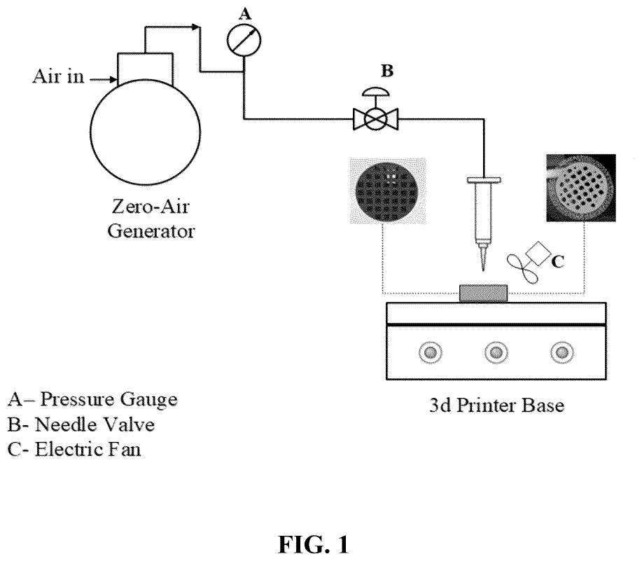

Cylindrical 3D monolithic structures were printed using a Creality Ender 3 FDM printer, with its traditional printhead modified with a 3D printed plastic fixture designed to hold a 5 cc Nordson EFD syringe. The syringes were equipped with 18G syringe tips, whilst 3D CAD design and slicing for the purpose of printing were done in Solidworks® 2021, and Ultimaker Cura® version 4.7.0, respectively. FIG. 1 highlights the pneumatic DIW system implemented based on modifications to the Ender 3 FDM printer. Controllable air supply was achieved using a Perma Pure portable Zero-Air™ generator and delivered directly to a 5 cc syringe that was affixed on a 3D printed fixture which replaced the heated extruder of the Ender 3. For controlled drying as needed during printing, the in-built fan designed to cool down the printer's extruder was repositioned and leveraged for drying (as shown in FIG. 1). Post printing, all structures were left to dry at room temperature until they can be nondestructively removed from the print plate. Post processing involved drying prints in an oven at a temperature of 120° C. for 5 h.

### Material Characterization

### Optical Excitation of DIW Prints

Post printing and drying, the 3D printed samples were excited by a 9 W 385-400 nm range LED lamp source for a period of 5 min, after which the lamp source was turned off to allow for videographic recording and visual observation of the photoluminescence (PL) response of the prints. For this test, a dark room was employed, and samples were initially left to stop glowing after being brought into the dark room from an adjacent space with ambient lighting where the printing and drying took place. Samples were placed on a flat dark surface to minimize reflection, and their positions were fixed throughout testing. Additionally, the excitation lamp was held fixed at a 10 cm height from the samples by a laboratory ring stand and clamp. Images for analysis of the PL response were taken at intervals of 10 s post excitation. Videographic evidence of PL was also obtained.

### Morphology and Chemical Characterization

For the printed ZnS:Cu-based catalysts and the SrAlO₄:Eu:Dy (Bp) phosphor, a scanning electron microscope (SEM) was employed to determine the morphology, while energy dispersive x-ray spectroscopy (EDS) was used to ascertain elemental composition. Both analyses were conducted on a JEOL LTD JXA-8530F electron microprobe analyzer with appropriate carbon coating applied on non-conductive samples prior to analyses. EDS and SEM images were obtained at accelerating voltages of 15 and 20 kV as needed for defined image resolutions based on the surface conditions of the provided samples.

### Surface Area and Porosity

A Tristar II plus system from Micrometrics Instrument corporation was used to determine the surface areas and pore size distributions of the samples. N₂ adsorption-desorption isotherms were obtained for the samples at 77.35K and were used to ascertain surface areas via the Brunauer-Emmett-Teller (BET) approach, while the pore diameter distributions of the samples were obtained via the Barrett-Joyner Halenda (BJH) approach.

### Ink Rheology

Rheological tests of all inks used in the printing were conducted on an Anton-Paar Inc modular compact rheometer (MCR) 302. All inks were tested with no lag time between preparation and testing to prevent dry out; inks were also maintained at room temperature while testing to mirror printing conditions. A ramp logarithmic shear rate profile in the range of 0.001-1000 s⁻¹ was selected to allow for comparison with published literature [5].

### UV-Vis Absorption and Photoluminescence

The light absorption profiles of the printed catalyst and SrAlO₄:Eu:Dy blue phosphor were obtained via UV-Vis spectroscopy. Absorption data were obtained via reflectance measurements in a PerkinElmer Inc Lambda 950 UV-Vis spectrophotometer. Light transmission through the sample was assumed to be minimal, and samples were prepared for testing by resizing the regular 3D printed structures to fit into the spectrophotometer. For the SrAlO₄:Eu:Dy blue phosphor, an ink made of just the phosphor and binder at 5 wt. % binder loading was prepared and formed into an oval solid for testing. The photoluminescence response of the DIW printed samples and the solid phosphor were obtained via a custom built fluorometer, excited externally with a 385-400 nm light source for whole luminescence of the prints. The custom fluorometer comprised a Roper Scientific/Acton Research Inc SP-150-S emission monochromator, SP-150-M excitation monochromator and NTE/CCD1340/100 EMB FG camera. Additionally, the system was coupled to a Newport Corporation Xe lamp-Oriel Apex model 70525.

### Non-Limiting, Exemplary Results

### DIW Printing and Luminescence

Described in this example are two classes of prints: a ZnS:Cu print and ZnS:Cu print with the SrAlO₄:Eu:Dy blue phosphor (Bp) incorporated within. Example mass breakdowns of catalyst material (ZnS:Cu), phosphor and binder for the two types of prints are highlighted in Table 1. For all prints, the binder content was kept at a fixed minimal value of 5 wt. %, and the catalyst to phosphor mass ratio for the luminous monolith was set at 2 to 1. The choice to double the catalyst mass with respect to the phosphor's mass was a design decision to ascertain whether at a low weight percent of phosphor, luminosity can still be achieved in the monolith. Ratios can be decided based off the intensity of the luminous response of the monolith, and in some embodiments the catalyst to phosphor mass ratio can be up to 10 to 1.

TABLE 1
Breakdown by mass of printed structures and
the mass of their individual components

| | | Total | ZnS:Cu | Phosphor | Methylcellulose |
|---|---|---|---|---|---|
| Print Name | Abbreviation | mass (g) | (g) | (g) | (MC)(g) |
| ZnS:Cu | ZnS:Cu | 3.175 | 3.016 | 0 | 0.159 |
| ZnS:Cu [symbol] | ZnS:Cu:Bp | 4.733 | 2.997 | 1.499 | 0.237 |
| Blue Phosphor | | | | | |

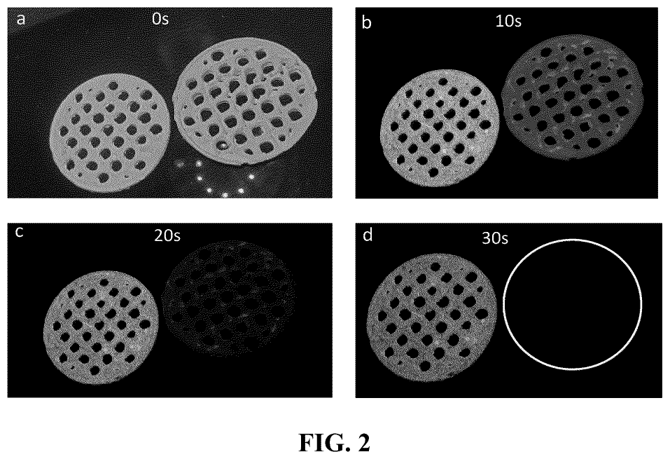

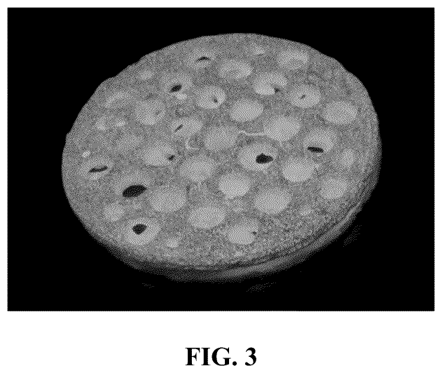

Pictures demonstrating the luminous response of the monoliths are shown in FIG. 2a-d. The bluish hue present in FIG. 2a is as a result of the LED lamp used in excitation over a duration of 5 min. Post termination of the lamp source, the ZnS:Cu print showed strong green luminescence (right side, FIG. 2b); this is typical of the reported behavior of ZnS:Cu [48]. However, its luminescence was short lived and was no longer evident after 30 s, as indicated by the dark region in FIG. 2d. Note that the white circle indicated in FIG. 2d was added to the pictures to indicate where the catalyst ZnS:Cu structure was located prior to its loss of visibility. On the left side of the prints in FIG. 2, the ZnS:Cu:Bp print showed a bluish luminescence and remained visible for the same time period and beyond as compared to ZnS:Cu. As shown in FIG. 3, whole structure luminescence was observed in the ZnS:Cu:Bp print. Additional information regarding the luminescence duration and wavelength profiles is presented subsequently.

### Rheological Profiles

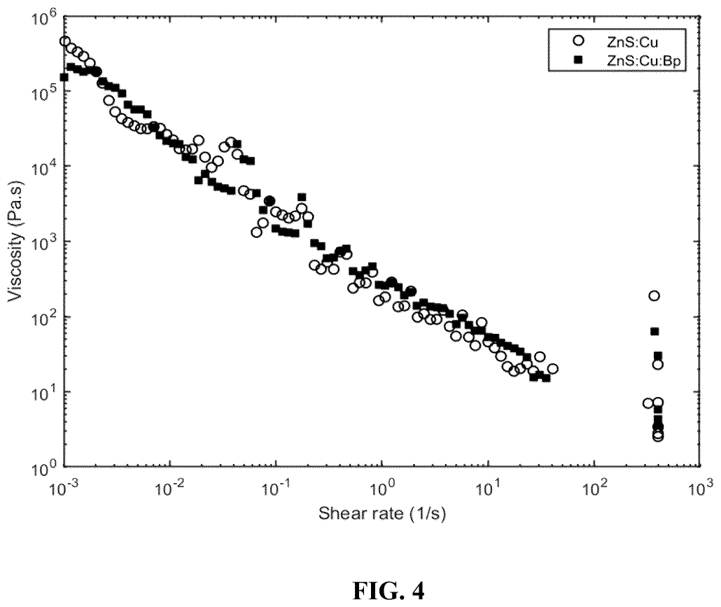

The rheological profiles of both types of inks were ascertained via increasing shear rate values. The shearing test range was programmed for a logarithmic ramp of 0.001 up to 1000 s⁻¹. FIG. 4 show that shear thinning behavior typical of pseudoplastic fluids was observed just before 100 s⁻¹, and a departure from viscoelasticity was observed beyond 100 s⁻¹. This can be due to inks drying out over the span of the test, since upon retrieval of spent samples after the viscosity tests, the ink samples were visibly hardened.

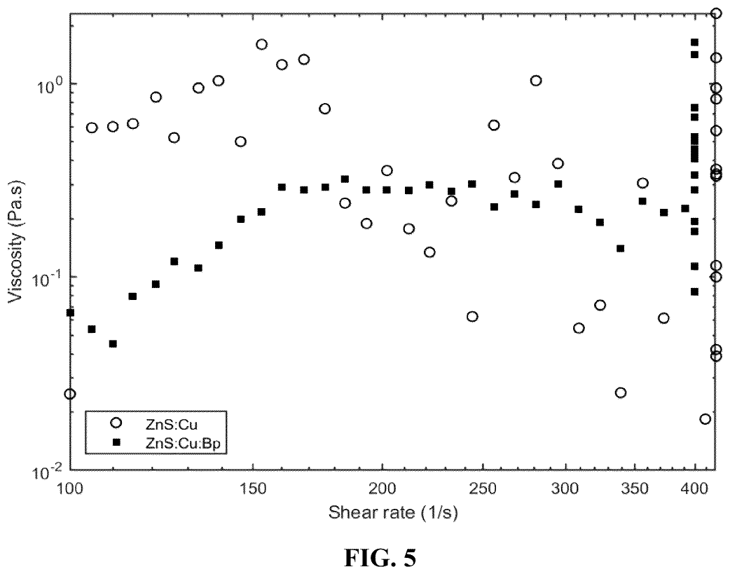

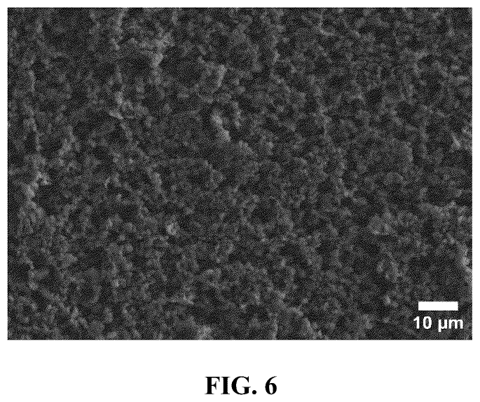

However, upon testing fresh inks for a shorter time duration at a starting shear rate of 100 s⁻¹ up to 1000 s⁻¹, as highlighted in FIG. 5, highly random behavior was observed. This result suggested that the developed inks were not suitable for high shear rate conditions.

Additionally, higher viscosity start values were observed for the ZnS:Cu ink as against its phosphor-based counterpart as indicated in FIG. 4. During printing, introducing the SrAlO₄:Eu:Dy into the ink mixture resulted in inks that dried out rapidly and showed difficulty in extrusion if left idle for more than a few hours. It was therefore necessary to compensate for this by introducing more water into the blue phosphor-based inks, thus leading to reductions in the starting viscosity values. Regardless of these lower start viscosity values, the ZnS:Cu:Bp left overnight in airtight syringes lost moisture and proved challenging to print. To avoid printing issues related to the loss of ink moisture, all prints were made less than 5 min after initial mixing of the materials.

### SEM Imaging

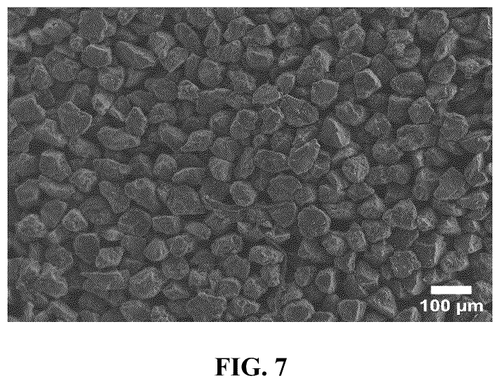

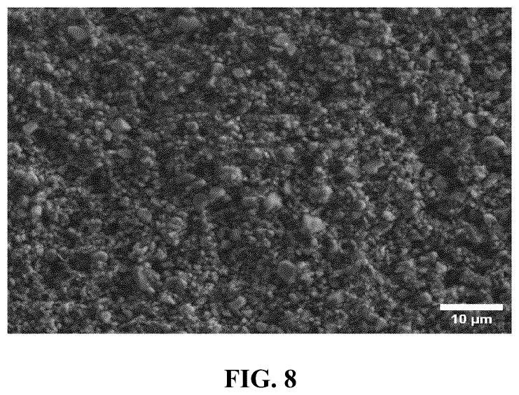

Scanning electron microscopy images of the printed ZnS:Cu, SrAlO₄:Eu:Dy (Bp), and ZnS:Cu:Bp are provided in FIG. 6-FIG. 8. As highlighted previously, SrAlO₄:Eu:Dy was not 3D printed but formed into an oval solid by means of the methylcellulose binder. Images were magnified as needed to allow for visualization of particle grains or to highlight essential elements in the material matrix. ZnS:Cu captured in FIG. 6 showed particle sizes under 4 μm. Its particles appeared densely packed and well connected with agglomeration spots visible. Without wishing to be bound by theory this can indicate the presence of the methylcellulose binder. The blue phosphor presented as irregularly shaped particles on the order of tens of microns as highlighted in FIG. 7a significant size increase from the particle size of ZnS:Cu. The dense nature of the packing can also have been ascribed to the phosphor being formed into an oval solid for testing, by aid of the methylcellulose binder prior to imaging. Lastly, as highlighted in FIG. 8, incorporation of the SrAlO₄:Eu:Dy blue phosphor into the ZnS:Cu matrix did not present a drastic change in visible morphology as all particles were under 10 μm, indicating that additional agglomeration did not occur. The ZnS:Cu catalyst powder covered the phosphor in the matrix given the particle size differences and the lower density and higher mass loading of the ZnS:Cu. The design decision to have twice as much ZnS:Cu as compared to the blue phosphor accounted for the relative stability in the particle sizes as noted in the figures.

### EDS Characterization

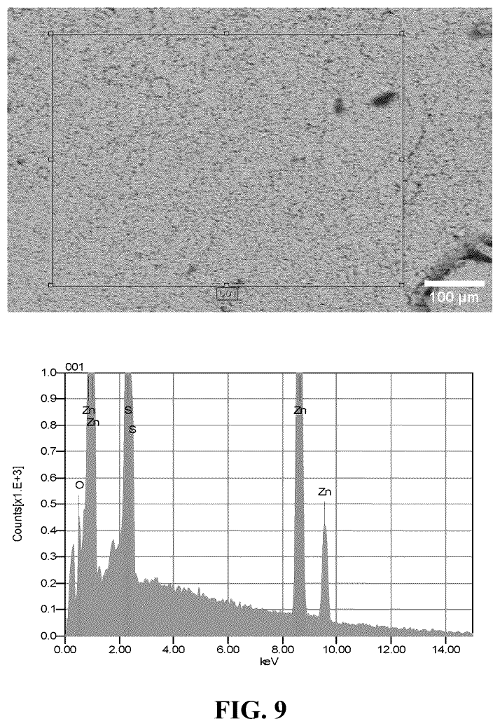

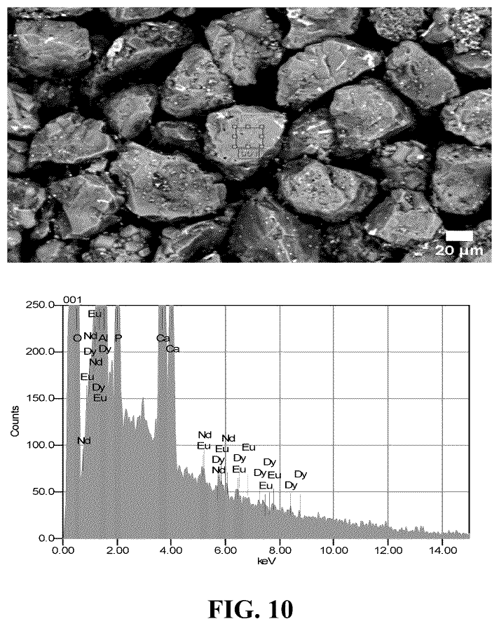

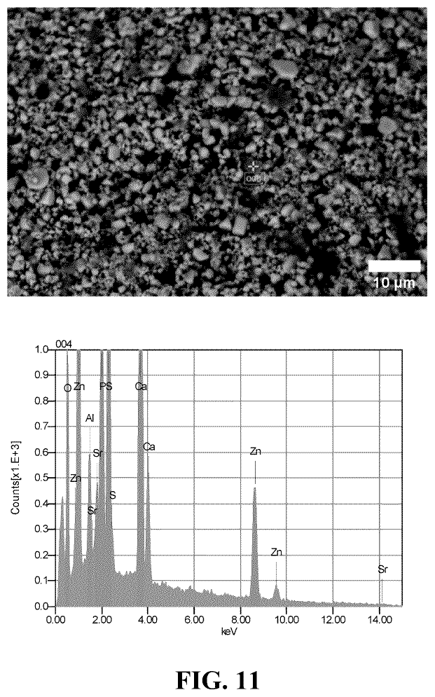

Energy Dispersive Xray Spectroscopy (EDS) was leveraged to ascertain the elemental composition of the printed ZnS:Cu, ZnS:Cu:Bp, and Bp samples. The elemental composition in terms of atomic weight % and elemental peak intensity plots are available in Table 2 and FIGS. 9-11. For the ZnS:Cu samples analyzed, S:Zn atomic ratios of 0.82:1 and 1.18:1 were observed for the non-phosphor and phosphor-based prints, respectively. A Cu signal was not detected in either the ZnS:Cu sample or its phosphor counterpart. The likely reason for this was the presence of very low Cu levels, i.e., levels below the detection limit of the EDS system. However, a clear difference in element types present in the analysis space was observed when the peak intensity plots of ZnS:Cu and ZnS:Cu:Bp were compared via FIGS. 9 and 11. For example, beyond the expected Zn and S, species like Al, Ca and Sr, from the phosphor incorporation were evident in ZnS:Cu:Bp print. Additionally, the presence of rare earth metal doping in the phosphor sample was indicated from the peak intensity plot presented in FIG. 10. Eu and Dy, two rare earth species, were present despite their low atomic percent levels. However, EDS is a semi-quantitative characterization technique which presents natural limitations in detecting elements that are sparsely present in a compound matrix. Cu doping confirmation in this study relies on FTIR characterization described herein, and the unique optical properties of the printed samples.

TABLE 2
EDS breakdown of elements in the 3D printed ZnS:Cu and
ZnS:Cu:Bp matrix, and the solid Bp/binder sample.

| | ZnS:Cu | ZnS:Cu:Bp | Phosphor (Bp) |
|---|---|---|---|
| Elements | (Atomic wt %) | (Atomic wt %) | (Atomic wt %) |
| Sr | — | 0.71 | — |
| Al | — | 1.96 | 26.24 |
| P | — | 10.05 | 1.65 |
| S | 42.38 | 11.21 | — |
| Ca | — | 19.29 | 13.18 |
| Zn | 51.48 | 9.52 | — |
| O | 6.13 | 47.26 | 58.77 |
| Cu | — | — | — |
| Eu | — | — | 0.07 |
| Dy | — | — | 0.01 |

### BET Characterization

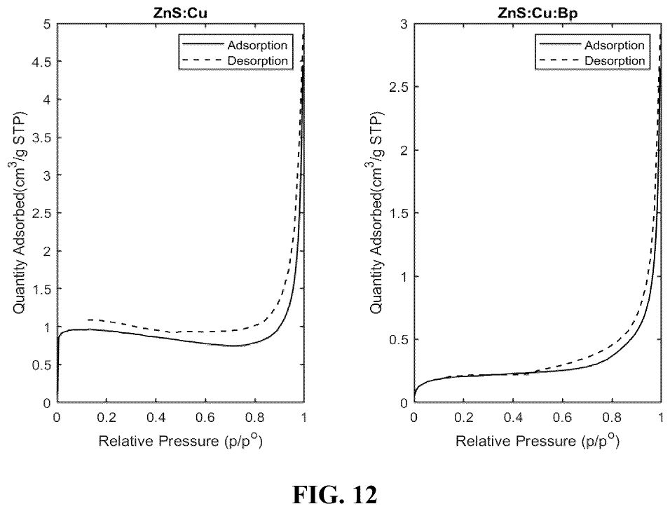

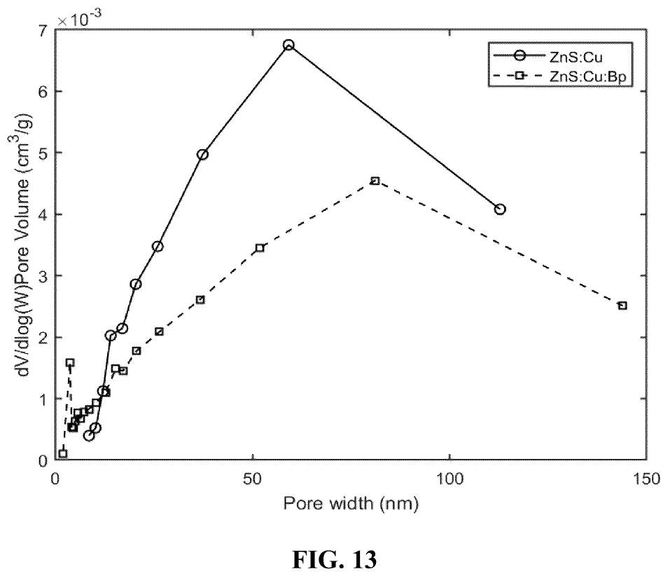

Adsorption isotherms were obtained from N₂ adsorption studies on the phosphor based and non-phosphor-based prints. The isotherms highlight the changes in adsorption capacity and pore size distribution based on the introduction of phosphor particles into the matrix. The isotherms obtained are displayed in FIG. 12. There was a marked decrease in adsorption capacity at all relative pressure values in the ZnS:Cu:Bp print. The decrease in adsorption capacity was also supported by the reduction in BET surface area values when comparing ZnS:Cu to its phosphor counterpart, as highlighted in Table 3. There was also a significant drop in the average pore width value supported by the differential pore volume distribution curves highlighted in FIG. 13, and the average pore width values summarized in Table 3. The drop in average pore width and surface area values can be attributed to the pore blocking phenomenon due to the large disparity in particle sizes between ZnS:Cu and Bp. The significant size disparity between ZnS:Cu and Bp ccan be observed by comparing their respective SEM images in FIGS. 6 and 7 respectively. Pore blocking induced by larger sized particles characterized by lower average pore width values and BET surface area have been described [49].

### UV-Vis Absorption and Photoluminescence Tests

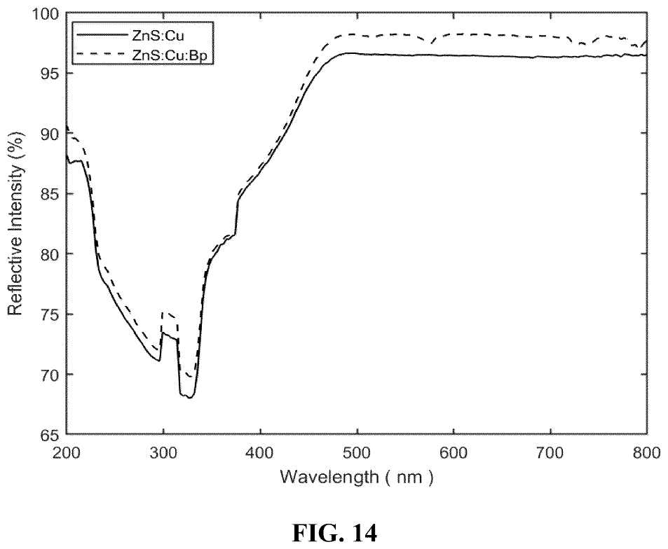

The UV-Vis diffuse reflectance spectra of the 3D printed ZnS:Cu and its phosphor variant (ZnS:Cu:Bp) are presented in FIG. 14. Ascertaining that an undesired deviation/shift in wavelength due to the introduction of the SrAlO₄:Eu:Dy (Bp) phosphor did not occur informed photocatalytic applications. It was observed that the incorporation of the phosphor into the ZnS:Cu catalyst led to a slight increase in reflective intensity across the wavelength range under consideration. The light absorption profile of the printed catalysts (ZnS:Cu and ZnS:Cu:Bp) and the Bp phosphor can then be obtained from the reflectance spectra.

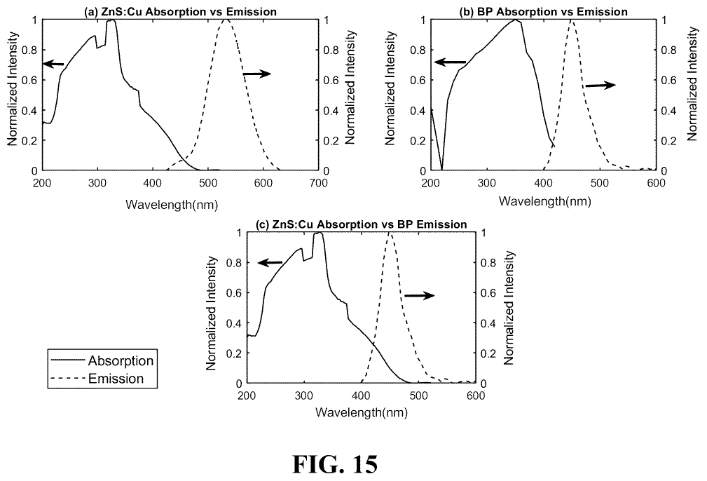

An intersection between the photoluminescence (PL) profile of the phosphor and the absorption profile of the catalyst allows for utilization of the afterglow luminescence of the blue phosphor by the ZnS:Cu catalyst. Shown in FIG. 15 a-c are the light absorption and emission profiles of the different materials. The intersection of phosphor emission and ZnS:Cu catalyst absorption is highlighted in FIG. 15c; therein the visible light absorption range of ZnS:Cu shows an intersection with the phosphor's emission range. Additionally, true to the visually observable greenish PL response of the ZnS:Cu catalyst (FIG. 2), a PL peak wavelength of ˜530 nm is shown in FIG. 15a.

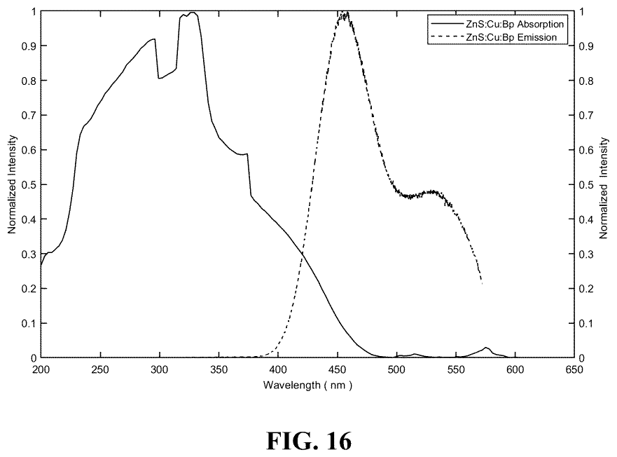

As highlighted in FIG. 16, when considering the PL (emission) response and absorption profile of the phosphor incorporated catalyst (ZnS:Cu:Bp), an intersection exists between its PL profile and absorption profile. This is key for photocatalytic applications that desire utilization of the material's afterglow to continue or extend an ongoing photocatalytic reaction. Additionally, this showed that ink formulation and subsequent 3D printing at even a catalyst to phosphor mass ratio of 2:1 did not suppress the PL response of the phosphor for this material combination. Furthermore, a double peak was observed in the PL profile of ZnS:Cu:Bp that was not present in the PL profile of either the Bp or ZnS:Cu individually. This double peak, centered at wavelength values of ˜450 and ˜530 nm respectively, showed the bluish/violet regime (˜450 nm) being the stronger of peaks as compared to the green peak at ˜530 nm. This was indicative of the Bp's strong dominance in the print matrix even when present at a lower weight percent.

Light absorption behaviors of both the 3D printed ZnS:Cu and ZnS:Cu:Bp were consistent with observed ZnS:Cu absorption behavior [17,22]. Both of the printed samples showed extended light absorption into the visible light range which is typical of ZnS:Cu, but not of ZnS. Additionally, the PL response of the 3D printed ZnS:Cu in this study was similar to the referenced DIW ZnS:Cu mechanoluminescent study which relied on a PDMS matrix for stress transfer [11]. Despite the limitations of the EDS system in detecting Cu in the printed matrix, optical evidence highlighted above alongside FTIR data indicates that indeed the printed monoliths emerge from a ZnS:Cu base. Additionally, the optical results, when compared to literature, indicated that the ink formulation containing the binder, water, catalyst, and persistent phosphor did not cause an undesired change in the expected light absorption properties of the prints. However, no basis for comparison exists to allow for the comparison of the PL response of the ZnS:Cu:Bp, as this paring via an additive manufacturing approach has not been previously explored and is unique to this work.

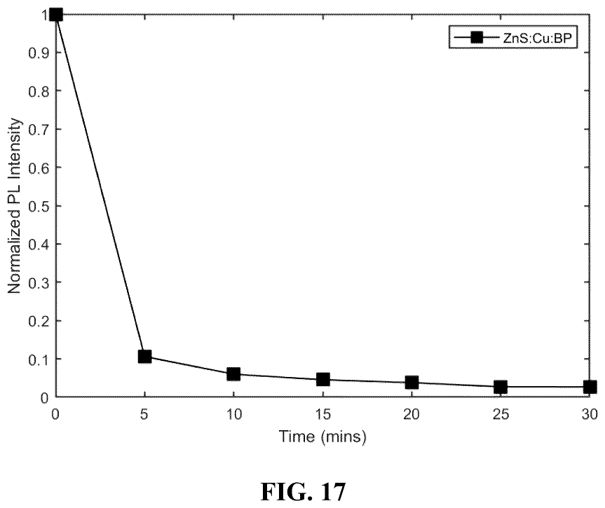

To ascertain the afterglow duration of the ZnS:Cu:Bp prints, its PL intensity was logged with respect to time. Given the short afterglow response displayed by ZnS:Cu (i.e. on the order of seconds, as confirmed in FIG. 2 a-d), its timed decay was not logged further. As highlighted in FIG. 17, ZnS:Cu:Bp showed an initial rapid decay in its high intensity PL values, followed by relatively consistent slow decay in its low intensity values. The low intensity PL remained consistent for up to 30 min. This stability in decay over a long period of time allows for predictable photocatalytic conversion rates based on fairly constant illumination.

### Conclusions

We report the first direct ink written ZnS:Cu luminous monolithic structures incorporated with long-lasting afterglow phosphor. The characterization studies that were conducted help to inform future printing efforts, especially in terms of limiting the shear induced within the printing assembly to produce successful prints. Described herein, the printing assembly was a pneumatic-based system where the extrusion pressure was maintained between 10 and 15 psig (68.95 kPa-103.42 kPa). In some embodiments, the printing assembly can comprise a hydraulic-based system, a mechanical gear based extruder system, or any print assembly known in the art. It was observed that the ZnS:Cu:Bp print exhibited steady illumination for up to 30 min despite a quick drop in intensity within the first 5 min of removing the external light source. Moreover, the prints that were developed produced illumination throughout the entire structure, thereby addressing the challenge of light attenuation faced by prior fiber optic-monolith reactor systems. Without wishing to be bound by theory, afterglow phosphors with longer afterglow duration and with the ability to form inks with rheology which retains their catalytic activity can be used.

### FTIR Characterization Method

FTIR studies were conducted in order to verify the Cu presence in the ZnS:Cu powder utilized in the study. A Nicolet iS50 FTIR spectrometer equipped with a Harrick Scientific Praying Mantis™ diffuse reflectance (DRIFTS) accessory and a HVC-4 reactor outfitted with KBr windows was employed to examine the FTIR spectra of ZnS:Cu and ZnS. Data were acquired at 4 cm-1 resolution, using 64 scans, and reported using the Kubelka-Munk (K-M) model.

### FTIR Characterization Results

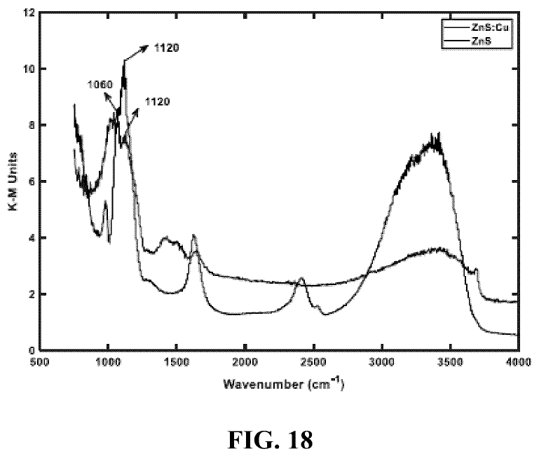

DRIFTS data obtained on ZnS:Cu and ZnS are shown in FIG. 18. The major features that are observed in the FTIR studies are in agreement with the spectra in a previously published study [50]. The split in the peak at 1120 cm-1 into 1120 and 1060 cm-1 is similar to prior literature and indicative of partial Cu substitution into the ZnS [50]. This confirms that indeed the starting material used in the study is ZnS:Cu. Additionally, and due to sample exposure to the ambient, O—H and C—O groups are present in the analysis space for both compounds. These groups are characterized respectively by peaks in the 3000-3600 cm-1 and 1500-1750 cm-1 ranges.

### REFERENCES

[1] H. Thakkar, S. Lawson, A. A. Rownaghi, F. Rezaci, Development of 3D-printed polymer-zeolite composite monoliths for gas separation, Chem. Eng. J. 348 (2018) 109-116.
[2] H. Thakkar, S. Eastman, A. Hajari, A. A. Rownaghi, J. C. Knox, F. Rezaci, 3D-Printed zeolite monoliths for CO₂ removal from enclosed environments, ACS Appl. Mater. Interfaces 8 (2016) 27753-27761, https://doi.org/10.1021/acsami.6b09647.
[3] V. Middelkoop, A. Vamvakeros, D. De Wit, S. D. Jacques, S. Danaci, C. Jacquot, Y. De Vos, D. Matras, S. W. Price, A. M. Beale, 3D printed Ni/Al₂O₃ based catalysts for CO₂ methanation-a comparative and operando XRD-CT study, J. CO₂ Util. 33 (2019) 478-487.
[4] J. F. Thompson, C. Bellerjeau, G. Marinick, J. Osio-Norgaard, A. Evans, P. Carry, R. A. Strect, C. Petit, G. L. Whiting, Intrinsic thermal desorption in a 3D printed multifunctional composite CO₂ sorbent with embedded heating capability, ACS Appl. Mater. Interfaces 11 (2019) 43337-43343, https://doi.org/10.1021/acsami.9b14111.
[5] M. J. Regufe, A. F. Ferreira, J. M. Loureiro, A. Rodrigues, A. M. Ribeiro, Electrical conductive 3D-printed monolith adsorbent for CO₂ capture, Microporous Mesoporous Mater. 278 (2019) 403-413.
[6] V. Middelkoop, K. Coenen, J. Schalck, M. V. S. Annaland, F. Gallucci, 3D printed versus spherical adsorbents for gas sweetening, Chem. Eng. J. 357 (2019) 309-319.
[7] W. Q. Peng, G. W. Cong, S. C. Qu, Z. G. Wang, Synthesis and photoluminescence of ZnS:Cu nanoparticles, Opt. Mater. 29 (2006) 313-317.
[8] B. L. Abrams, L. Williams, J.-S. Bang, P. H. Holloway, Thermal quenching of cathodoluminescence from ZnS: Ag, Cl powder phosphors, J. Appl. Phys. 97 (2005).
[9] H. Yang, P. H. Holloway, B. B. Ratna, Photoluminescent and electroluminescent properties of Mn-doped ZnS nanocrystals, J. Appl. Phys. 93 (2003) 586-592.
[10] C. D. Brubaker, K. N. Newcome, G. K. Jennings, D. E. Adams, 3D-Printed alternating current electroluminescent devices, J. Mater. Chem. C 7 (2019) 5573-5578, https://doi.org/10.1039/C9TC00619B.
[11] D. K. Patel, B.-E. Cohen, L. Etgar, S. Magdassi, Fully 2D and 3D printed anisotropic mechanoluminescent objects and their application for energy harvesting in the dark, Mater. Horiz. 5 (2018) 708-714.
[12] S. M. Jeong, S. Song, K.-I. Joo, J. Kim, S.-H. Hwang, J. Jeong, H. Kim, Bright, wind-driven white mechanoluminescence from zinc sulphide microparticles embedded in a polydimethylsiloxane elastomer, Energy Environ. Sci. 7 (2014) 3338-3346.
[13] H. Shim, B. Allabergenov, J. Kim, H. Y. Noh, H.-K. Lyu, M.-J. Lee, B. Choi, Highly bright flexible electroluminescent devices with retroreflective electrodes, Advanced Materials Technologies 2 (2017), 1700040, https://doi.org/10.1002/admt.201700040.
[14] P. D. Rack, P. H. Holloway, The structure, device physics, and material properties of thin film electroluminescent displays, Mater. Sci. Eng. R Rep. 21 (1998) 171-219, https://doi.org/10.1016/S0927-796X (97) 00010-7.
[15] S. Krishnan, H. Van der Walt, V. Venkatesh, V. B. Sundaresan, Dynamic characterization of elastico-mechanoluminescence towards structural health monitoring, J. Intell. Mater. Syst. Struct. 28 (2017) 2458-2464.
[16] R. Chauhan, A. Kumar, R. P. Chaudhary, Photocatalytic degradation of methylene blue with Cu doped ZnS nanoparticles, J. Lumin. 145 (2014) 6-12.
[17] M. Dong, P. Zhou, C. Jiang, B. Cheng, J. Yu, First-principles investigation of Cu-doped ZnS with enhanced photocatalytic hydrogen production activity, Chem. Phys. Lett. 668 (2017) 1-6.
[18] M. Kimi, L. Yuliati, M. Shamsuddin, Preparation of high activity Ga and Cu doped ZnS by hydrothermal method for hydrogen production under visible light irradiation, J. Nanomater. 16 (2015) 200, https://doi.org/10.1155/2015/195024, 200.
[19] H. Labiadh, T. B. Chaabane, L. Balan, N. Becheik, S. Corbel, G. Medjahdi, R. Schneider, Preparation of Cu-doped ZnS QDs/TiO2 nanocomposites with high photocatalytic activity, Appl. Catal. B Environ. 144 (2014) 29-35.
[20] G.-J. Lec, S. Anandan, S. J. Masten, J. J. Wu, Photocatalytic hydrogen evolution from water splitting using Cu doped ZnS microspheres under visible light irradiation, Renew. Energy 89 (2016) 18-26.
[21] X. Liu, Y. Zhang, S. Matsushima, T. Sugiyama, H. Hojo, H. Einaga, Rational design of Cu-Doped ZnS nanospheres for photocatalytic evolution of H2 with visible light, ACS Appl. Energy Mater. 5 (2022) 1849-1857.
[22] W. Luo, J. Ying, S. Yu, X. Yang, Y. Jia, M. Chen, H. Zhang, J. Gao, Y. Li, Y.-W. Mai, ZnS:Cu powders with strong visible-light photocatalysis and pyro-catalysis for room-temperature dye decomposition, Ceram. Int. 46 (2020) 12096-12101.
[23] A. Serr'a, L. Philippe, Simple and scalable fabrication of hairy ZnO@ ZnS core@ shell Cu cables for continuous sunlight-driven photocatalytic water remediation, Chem. Eng. J. 401 (2020), 126164.
[24] N. S. Karan, D. D. Sarma, R. M. Kadam, N. Pradhan, Doping transition metal (Mn or Cu) ions in semiconductor nanocrystals, J. Phys. Chem. Lett. 1 (2010) 2863-2866.
[25] V. Toma ̆si'c, F. Jovi'c, State-of-the-art in the monolithic catalysts/reactors, Appl. Catal. Gen. 311 (2006) 112-121.
[26] S. Govender, H. B. Friedrich, Monoliths: a review of the basics, preparation methods and their relevance to oxidation, Catalysts 7 (2017) 62, https://doi.org/10.3390/catal7020062.
[27] A. Cybulski, J. A. Moulijn, Monoliths in heterogeneous catalysis, Catal. Rev. 36 (1994) 179-270, https://doi.org/10.1080/01614949408013925.
[28] M. Tahir, B. Tahir, Z. Y. Zakaria, A. Muhammad, Enhanced photocatalytic carbon dioxide reforming of methane to fuels over nickel and montmorillonite supported TiO2 nanocomposite under UV-light using monolith photoreactor, J. Clean. Prod. 213 (2019) 451-461, https://doi.org/10.1016/j.jclepro.2018.12.169.
[29] M. Tahir, B. Tahir, Dynamic photocatalytic reduction of CO2 to CO in a honeycomb monolith reactor loaded with Cu and N doped TiO2 nanocatalysts, Appl. Surf. Sci. 377 (2016) 244-252, https://doi.org/10.1016/j.apsusc.2016.03.141.
[30] S. Sharma, S. Basu, Highly reusable visible light active hierarchical porous WO3/SiO2 monolith in centimeter length scale for enhanced photocatalytic degradation of toxic pollutants, Separ. Purif. Technol. 231 (2020), 115916, https://doi.org/10.1016/j.seppur.2019.115916.
[31] K. Nakata, T. Kagawa, M. Sakai, S. Liu, T. Ochiai, H. Sakai, T. Murakami, M. Abe, A. Fujishima, Preparation and photocatalytic activity of robust titania monoliths for water remediation, ACS Appl. Mater. Interfaces 5 (2013) 500-504, https://doi. org/10.1021/am302654r.
[32] H. Lin, K. T. Valsaraj, Development of an optical fiber monolith reactor for photocatalytic wastewater Treatment, J. Appl. Electrochem. 35 (2005) 699-708, https://doi.org/10.1007/s10800-005-1364-x.
[33] J. T. Carneiro, R. Berger, J. A. Moulijn, G. Mul, An internally illuminated monolith reactor: pros and cons relative to a slurry reactor, Catal. Today 147 (2009) S324-S329, https://doi.org/10.1016/j.cattod.2009.07.041.
[34] H. Chen, F. Chu, L. Yang, O. Ola, X. Du, Y. Yang, Enhanced photocatalytic reduction of carbon dioxide in optical fiber monolith reactor with transparent glass balls, Appl. Energy 230 (2018) 1403-1413, https://doi.org/10.1016/j. apenergy.2018.09.081.
[35] T. Wang, L. Yang, X. Du, Y. Yang, Numerical investigation on CO2 photocatalytic reduction in optical fiber monolith reactor, Energy Convers. Manag. 65 (2013) 299-307, https://doi.org/10.1016/j.enconman.2012.08.021.
[36] P. Du, J. T. Carneiro, J. A. Moulijn, G. Mul, A novel photocatalytic monolith reactor for multiphase heterogeneous photocatalysis, Appl. Catal. Gen. 334 (2008) 119-128, https://doi.org/10.1016/j.apcata.2007.09.045.
[37] K.-P. Yu, G. W.-M. Lec, A.-J. Hung, Removal of indoor a-pinene with a fiber optic illuminated honeycomb monolith photocatalytic reactor, J. Environ. Sci. Health, Part A 49 (2014) 1110-1115, https://doi.org/10.1080/10934529.2014.897146.
[38] T. Boger, A. K. Heibel, C. M. Sorensen, Monolithic catalysts for the chemical industry, Ind. Eng. Chem. Res. 43 (2004) 4602-4611, https://doi.org/10.1021/ie030730q.
[39] W. Wang, Y. Ku, The light transmission and distribution in an optical fiber coated with TiO2 particles, Chemosphere 50 (2003) 999-1006, https://doi.org/10.1016/S0045-6535 (02) 00641-0.
[40] K. Hofstadler, R. Bauer, S. Novalic, G. Heisler, New reactor design for photocatalytic wastewater treatment with TiO2 immobilized on fused-silica glass fibers: photomineralization of 4-chlorophenol, Environ. Sci. Technol. 28 (1994) 670-674.
[41] N. J. Peill, M. R. Hoffmann, Development and optimization of a TiO2-coated fiber-optic cable reactor: photocatalytic degradation of 4-chlorophenol, Environ. Sci. Technol. 29 (1995) 2974-2981.
[42] W. Choi, J. Y. Ko, H. Park, J. S. Chung, Investigation on TiO2-coated optical fibers for gas-phase photocatalytic oxidation of acetone, Appl. Catal. B Environ. 31 (2001) 209-220.
[43] X. Liu, X. Chen, Y. Li, B. Wu, X. Luo, S. Ouyang, S. Luo, A. A. A. Kheraif, J. Lin, A g-C3N4@Au@SrAl2O4:Eu2+,Dy3+ composite as an efficient plasmonic photocatalyst for round-the-clock environmental purification and hydrogen evolution, J. Mater. Chem. A 7 (2019) 19173-19186, https://doi.org/10.1039/C9TA06423K.
[44] Q. Zhou, F. Peng, Y. Ni, J. Kou, C. Lu, Z. Xu, Long afterglow phosphor driven round-the-clock g-C3N4 photocatalyst, J. Photochem. Photobiol. Chem. 328 (2016) 182-188.
[45] C. Zhou, P. Zhan, J. Zhao, X. Tang, W. Liu, M. Jin, X. Wang, Long-lasting CaAl2O4:Eu2+, Nd3+ phosphor-coupled g-C3N4 QDs composites for the round-the-clock photocatalytic methyl orange degradation, Ceram. Int. 46 (2020) 27884-27891.
[46] J. Tang, X. Liu, Y. Liu, X. Zhang, Y. Lin, L. Chen, D. Fang, J. Wang, Novel Z-scheme Sr2MgSi2O7: Eu2+, Dy3+/Ag3PO4 photocatalyst for round-the-clock efficient degradation of organic pollutants and hydrogen production, Chem. Eng. J. 435 (2022), 134773.
[47] L. Lei, D. Wang, Y. Kang, Y. de Rancourt de Mim'erand, X. Jin, J. Guo, Phosphor-Enhanced, visible-light-storing g-C3N4/Ag3PO4/SrAl2O4:Eu2+,Dy3+ photocatalyst immobilized on fractal 3D-printed supports, ACS Appl. Mater. Interfaces 14 (2022) 11820-11833, https://doi.org/10.1021/acsami.1c23650.
[48] P. Pegallapati, M. Reddivari, B. Pejjai, T. Kummara, T. R. R. Kotte, Synthesis of Cu-doped ZnS nano-powder by chemical co-precipitation process, Mater. Today: Proc. (2023), https://doi.org/10.1016/j.matpr.2023.02.419.
[49] F.-C. Huang, J.-F. Lee, C.-K. Lee, H.-P. Chao, Effects of cation exchange on the pore and surface structure and adsorption characteristics of montmorillonite, Colloids Surf. A Physicochem. Eng. Asp. 239 (2004) 41-47, https://doi.org/10.1016/j. colsurfa.2003.10.030.
[50] S. Ummartyotin, N. Bunnak, J. Juntaro, M. Sain, H. Manuspiya, Synthesis and luminescence properties of ZnS and metal (Mn, Cu)-doped-ZnS ceramic powder, Solid State Sci. 14 (2012) 299-304.

### Example 3

### Direct Ink Written Luminous Monoliths for Round the Clock H₂S Photocatalysis

Gas phase H₂S photocatalysis remains an untapped field of research with numerous limitations abound; not least being the danger posed to life by the gas itself. However, as a source of hydrogen attainable at lower thermodynamic energy cost as compared to water splitting, research in this field must be a priority. Described herein, we show the efficacy of adsorbent based Direct Ink Written (DIW) luminous structures for H₂S photocatalysis. This has been investigated with the ultimate objective of sustaining H₂S conversion in the dark post termination of a traditional light source. Additionally, the wholly intrinsic illumination of the 3D printed monoliths in the dark is a strategy at providing an alternative to fiber optic cable-monolith systems which have been previously proposed to improve light distribution in photocatalytic systems. Summarily, it is shown that incorporating H₂S favorable adsorbents such as Zeolite 13X and activated carbon into ZnS:Cu matrix, and fashioning DIW monolithic contactors can lead to not only improved conversion under light conditions but also extended H₂S conversion from the afterglow of the monoliths is feasible due to the synergistic effect between Zeolite adsorbent and SrAl204 based long afterglow phosphor.

### Introduction

Direct ink writing (DIW) as a subset of additive manufacturing involves the forming of 3D shapes and forms from powder-based materials via leveraging viscoelastic inks developed from the starting powder/catalyst. As a 3D printing technique, DIW has found utility in a variety of gas separation, catalysis and adsorption based studies[1-4]. For these applications, the 3D printed structures take the form of monoliths. The benefits of monolithic contactors as regards to improved mass transfer properties and lower pressure drop when used in flow systems is well documented[5-7]. However, for photocatalytic applications, monoliths present as a challenging catalyst form to use; this is due to poor light penetration via the channels of the monolith. Studies focused on the tandem utilization of light transmitting fiber optic cables and conventionally manufactured monolith structures have been published to enhance photocatalytic applications involving monoliths[8-12].

Lin et al's[8] approach utilized fiber optic cables distributed within a ceramic honeycomb monolith. The cables were lightly coated with TiO₂ to allow for light refraction while the ceramic monolith had TiO₂ catalyst coated within its channels. By this approach, their study achieved utility of a monolith system and its inherent benefits (mass transfer and low pressure drop advantages etc.), while improving its light utility/quantum efficiency. Researchers have shown interest in prolonging photocatalytic reactions long after the lamp/external light source has been turned off via the use of long after glow phosphors[13]. Long afterglow phosphors are luminescent materials that produce extended illumination post light excitation due to the trapping and subsequent release of holes and electrons[13,14]. There have been studies investigating numerous phosphor-photocatalyst pairs for applications ranging from organic compound degradation to hydrogen generation from water[15-20]. However, none of these studies focused on fabricating 3D monoliths from phosphor-photocatalyst pairs.

Dual functional materials fuse both adsorption type materials and materials with catalytic properties to facilitate the isothermal capture and conversion of single or multiple pollutants[21]. This integrated approach has been explored for varying classes of catalytic applications, photocatalysis inclusive[22,23]. The benefits of such integration, beyond making available the intrinsic properties of the adsorbent and photocatalyst, is that improved pollutant adsorption on the hybrid material is made possible alongside the deceleration of electron hole recombination effect[24]. DIW of dual functional materials have been explored for an array of catalytic applications ranging from CO₂ capture and oxidative dehydrogenation of ethane to direct air capture of CO₂ and its utilization in the dehydrogenation of propane[25,26]. Additionally, DIW of TiO₂ photocatalyst have been described [27,28], however to the best of our knowledge, no study in the literature has investigated DIW dual functional photocatalysts incorporated with long afterglow phosphors.

H₂S is a deleterious gas that is a by-product of numerous industrial processes. Wastewater treatment plants, natural gas and crude oil reservoirs are some of the sources that have significant levels of H₂S [29]. Despite its toxicity, the use of H₂S as a source of hydrogen makes studies focused on H₂S decomposition key. Photocatalytic dissociation of H₂S leverages materials that possess photocatalytic properties and can be activated in the UV/visible region. The decomposition of H₂S over a photocatalyst is highlighted in reactions 1 and 2 [30-33].

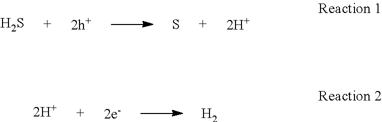

There are few studies exploring gas phase photocatalytic H₂S splitting with hydrogen production reported or as the end goal [34-38]. Studies have taken advantage of a combination of single and composite catalysts such as: ZnO, ZnS, CdS, ZnS:Cu, (CdS+ZnS)/Fe₂O₃ and CuGa_{1.6}Fe_{0.4}O₂ to mention a few. Gujun et al's investigation of variations of ZnS indicated that ZnS:Cu produced over 20 times as much hydrogen from H₂S splitting as compared to base ZnS. They attributed this improved hydrogen production to the shift in light absorption range to the visible region when ZnS was modified with Cu²⁺. Beyond H₂S photocatalysis, ZnS:Cu has found utility in other photocatalytic studies [39-43].

H₂S favorable adsorbents (Zeolite 13X and Activated carbon), a wavelength compatible long afterglow phosphor (SrAlO₄:Eu:Dy), and ZnS:Cu catalyst can form viscoelastic inks that are 3D printable into DIW luminous monolithic contactors. The intrinsic luminosity of the printed monoliths is an approach to provide an alternative to fiber optic cable-monolith system [8]. The afterglow response can convert H₂S after the lamp source was turned off. The specific long afterglow phosphor was selected based on its favorable emission profile which intersects with the absorption profile of the ZnS:Cu photocatalyst, while the choice of adsorbents (Activated carbon and Zeolite) was in relation to their reported efficacies towards H₂S adsorption. This is the first reported investigation of direct ink written dual functional materials for gas phase H₂S photocatalysis, and additionally the first investigation into incorporating long afterglow phosphors into direct ink written structures.

### Experimental Section

### Materials

ZnS:Cu with reported particle size less than 10 μm was purchased from Phosphor Technology LTD (United Kingdom) and used as received without any additional processing. For the binder, Methylcellulose (400 centipoise) was purchased from Sigma Aldrich and the same supplier supplied both the Activated carbon (100 mesh) and Zeolite 13X (2 μm) adsorbent. Custom research quantity SrAlO₄ phosphor doped with Eu and Dy (SrAlO₄:Eu:Dy) designed to give an afterglow blueish response was obtained from PhosphorTech Corporation (Kennesaw, GA) and used as received. The SrAlO₄:Eu:Dy phosphor is not a commercial option offered by the supplier but was synthesized upon request. A material extrusion based Creality Ender 3 printer was modified with an auxiliary pneumatic system to allow for ink dispensing and control. Syringes and corresponding piston and air delivery fixtures used with the system were supplied by Nordson EFD.

An H₂S permeation tube (KinTek Corporation) rated for an emission rate of 6,354 ng/min at 50° C. was used to generate known concentrations of H₂S using a KinTek 491 MB gas generator. An Industrial Scientific MX6 iBrid gas monitor equipped with H₂S, H₂ and SO₂ electrochemical sensors was used for gas concentration logging. The photocatalytic reactor used in the study was fabricated by Chemglass Life Sciences LLC, based on design specifications and conceptual drawings provided, and ultra-high purity Nitrogen was supplied by Matheson Tri-Gas Inc.

### DIW of Catalysts

### Ink Preparation and 3D Printing

Inks of appropriate rheology intended to produce 6 unique structures with fixed catalyst:adsorbent:phosphor ratio were developed from the ZnS:Cu, Activated carbon, Zeolite 13X, SrAlO₄:Eu:Dy and Methylcellulose (MC) materials. For each of the inks produced a binder content of 5 wt. % of MC was used, and catalyst, adsorbent and phosphor made up the remainder as needed. Cylindrical 4 cm in diameter 3D monolithic structures were printed using a Creality Ender 3 FDM printer, with its traditional printhead replaced by a 3D printed plastic fixture designed to hold a 5 cc Nordson EFD syringe. Syringe tips (18G in size) were used for all prints whilst 3D CAD design and slicing for the purpose of printing were done in Solidworks® 2021, and Ultimaker Cura® version 4.7.0, respectively.

### Material Characterization

Material characterization conducted covered microscopic imaging via scanning electron microscope (SEM), elemental composition analysis via energy dispersive x-ray spectroscopy (EDS), and surface area and porosity analysis via Brunauer-Emmett-Teller (BET) characterization. Additionally, rheological characterization of the developed inks, and light absorption and photoluminescence response characterization were also conducted. SEM and EDS characterization were conducted on a JEOL LTD's JXA-8530F electron microprobe analyzer with the objective of ascertaining the printed samples' morphologies and elemental compositions, respectively.

A Tristar II plus system from Micrometrics Instrument Corporation was used to obtain N₂.adsorption isotherm data at a temperature of 77.35K; sample surface area and pore size distribution were then obtained via the BET method and the Barrett-Joyner Halenda (BJH) method respectively. For the rheological profile of the developed inks, an Anton-Paar Inc modular compact rheometer (MCR) 302 was used. Freshly prepared inks were tested at room temperature at a logarithmic shear rate profile in the range of 0.001 and 1000 s⁻¹. UV-Vis reflection tests were conducted on a PerkinElmer Inc Lambda 950 UV-Vis spectrometer, while photoluminescence profiles of the prints were obtained via a fluorometer. The fluorometer was custom assembled and consists of Roper Scientific/Acton Research Inc's SP-150-S emission monochromator, SP-150-M excitation monochromator and NTE/CCD-1340/100 EMB FG camera. Additionally, the system possesses Newport Corporation's Xe lamp-Oriel Apex model 70525. In addition to fluorometry, the luminous response of the printed monoliths was indicated by visual inspection which was achieved via excitation by a 9-watt black LED bulb and the afterglow response captured via camera.

### Photocatalytic Activity Tests

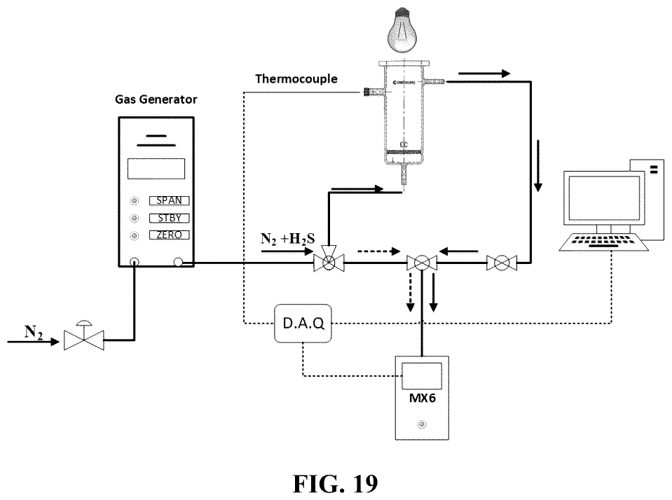

Activities of the printed catalysts were ascertained via a series of photocatalytic tests in the experimental rig depicted in FIG. 19. The experimental rig consisted of a KinTek Inc's 491M-B gas generator which works in tandem with a H₂S permeation tube. H₂S was generated by the gas generator which required ultra-high purity nitrogen delivered to its inlet at a pressure of 90 psig. The generator subsequently delivered 10 ppm of H₂S at a flow rate of 190 mL/min to the inlet of a borosilicate photocatalytic reactor. When operated in zero mode, the gas generator also doubled as a purge gas source for the reactor; allowing a constant flow of only pure N₂ through the stainless-steel lines of the system.

Gas concentration at the exit of the reactor was monitored by an Industrial scientific MX6 iBrid gas monitor fitted with H₂S, SO₂ and H₂ electrochemical sensors. Photocatalytic experiments occurred in an oxygen-free atmosphere hence an SO₂ signal was not expected from the sensor. Additionally, the H₂ sensor on the MX6 although rated for 0-2000 ppm has uncertainty in the lower range, hence no H₂ signal is reported for this study. As light sources, two 300 W LED bulbs and a 9.5 W black light bulb with an emission range of 385-400 nm serve as initiator for the photocatalytic reaction and an excitation source for the incorporated phosphor respectively.

Four main categories of photocatalytic experiments were conducted on the printed catalysts. Firstly, background tests were conducted to ensure that the adsorbents and phosphor on their own accord cannot facilitate the required photocatalytic reaction, and that no losses in H₂S concentration on account of passage through the reactor were experienced. The second class of experiments—the “dark adsorption” tests-consisted of the printed materials being exposed to H₂S until breakthrough occurred. These tests were conducted in the absence of any ambient or direct lighting. Long term and cyclic photocatalytic destruction tests serve as the third and fourth test categories respectively. The objective of the long-term photocatalytic activity tests was to determine the catalyst's response over a significant duration of time. The intended time duration of study was a 6-hour period, 4 hours with the light on, and 2 hours with the light turned off, while the H₂S concentration was continuously monitored.

However, where the 6-hour duration was not attainable due to catalyst non-performance, a shorter duration was used. The objective of the cyclic tests was to ascertain the effect that the luminous afterglow of the phosphor-based prints had on their ability to sustain H₂S conversion when the lamp source was turned off. This test was achieved via consecutive periods of charging and discharging the phosphor composites by action of light. Alternating periods of 1 hr on and 1 hr off were employed for this test; when this duration was not possible, cycling was kept to 20 minutes intervals of light on and off.

### Results and Discussion

### Characterization of DIW Prints

Six monolith structures as highlighted in Table 1 (abbreviations used for each print provided) were printed from the inks developed and subsequently excited for visual confirmation of their luminous response as described in the experimental section. In all cases, a catalyst:adsorbent:phosphor ratio of 1:1:1 was desired and maintained except in the case of phosphor incorporated ZnS:Cu for which the active catalyst to phosphor ratio was 2:1. This was done in order to maintain uniform phosphor mass in all phosphor based prints and also match the mass of catalyst in the ZnS:Cu print which had to be increased to twice the mass loading as compared to other prints. This increased mass loading for ZnS:Cu provided detectable H₂S conversion.

TABLE 1
Mass breakdown of the six printed monolith structures

| | | Total | ZnS:Cu | Phosphor | | Activated | |
|---|---|---|---|---|---|---|---|
| Print Name | Abbreviation | mass (g) | (g) | (g) | Zeolite | Carbon | MC |
| ZnS:Cu | ZnS:Cu | 3.178 | 3.016 | 0 | 0 | 0 | 0.159 |
| ZnS:Cu + | ZnS:Cu:Zeo | 3.280 | 1.558 | 0 | 1.558 | 0 | 0.164 |
| Zeolite | | | | | | | |
| ZnS:Cu + AC | ZnS:Cu:AC | 3.214 | 1.527 | 0 | 0 | 1.527 | 0.161 |
| ZnS:Cu + | ZnS:Cu:Bp | 4.733 | 2.997 | 1.499 | 0 | 0 | 0.237 |
| Phosphor | | | | | | | |
| ZnS:Cu + | ZnS:Cu:Zeo:Bp | 4.755 | 1.524 | 1.525 | 1.467 | 0 | 0.238 |
| Phosphor + | | | | | | | |
| Zeolite | | | | | | | |
| ZnS:Cu + | ZnS:Cu:AC:Bp | 4.695 | 1.487 | 1.488 | 0 | 1.487 | 0.235 |
| Phosphor + AC | | | | | | | |

*composites contained 5 wt. % methyl cellulose

Non-limiting, exemplary rheological and SEM data are described herein; rheological data show pseudoplastic behaviors of the inks at low to intermediate shear rate values (0.001-100 s⁻¹). A clear departure from pseudoplastic behavior is noted beyond shear rate value of 100 s⁻¹, even for ZnS:Cu which had no adsorbent or phosphor incorporated. The SEM data show the differences in particle sizes of the individual components as well as good dispersion of the components within the matrix. Lastly, EDS data generated indicates the elemental composition of the prints. FTIR of the base ZnS:Cu is reported in our prior study [44].

TABLE 2
BET Summary of relevant surface area for prints containing
the catalyst (ZnS:Cu), and/or one of the adsorbents -zeolite
“zeo” and activated carbon “AC” and the blue phosphor (Bp)

| | | BJH Adsorption average |
|---|---|---|
| Print name | BET surface Area (m²/g) | pore width(nm) |
| ZnS:Cu | 4.8581 | 62.5505 |
| ZnS:Cu:Bp | 0.760 | 41.2430 |
| ZnS:Cu:Zeo | 383.8201 | 5.8843 |
| ZnS:Cu:Zeo:Bp | 309.0708 | 5.2863 |
| ZnS:Cu:AC | 375.5940 | 6.0081 |
| ZnS:Cu:AC:Bp | 223.3366 | 5.9166 |

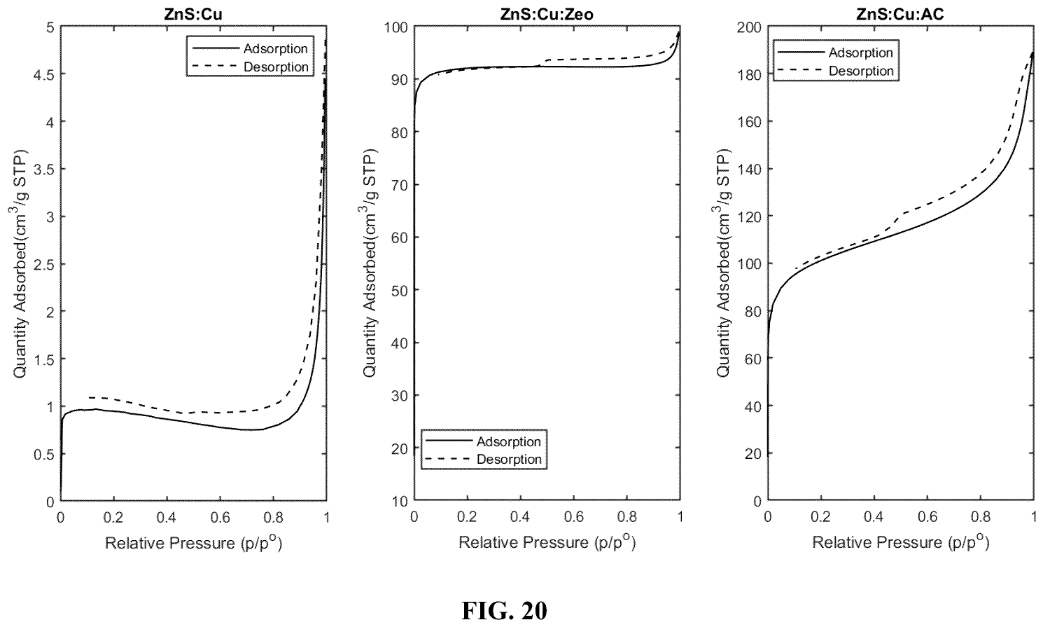

The results from the BET analysis conducted on the samples show that available surface area and micropore volume is vastly improved by the incorporation of either adsorbent type as indicated by the BET summary in Table 2 and isotherm in FIG. 20. Furthermore, introduction of the phosphor into the matrix reduces the available surface area and micropore volume; this is less apparent in the zeolite-based phosphor matrix as against the Activated carbon-based matrix.

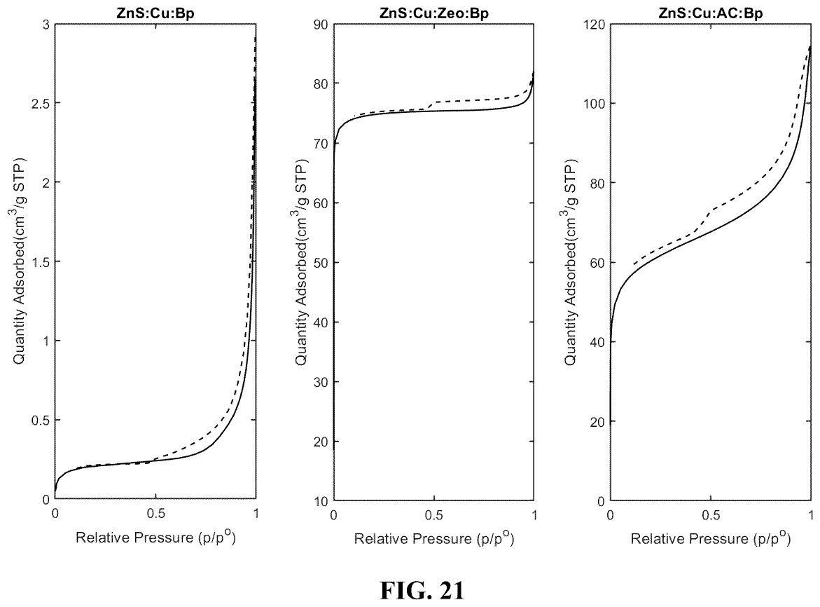

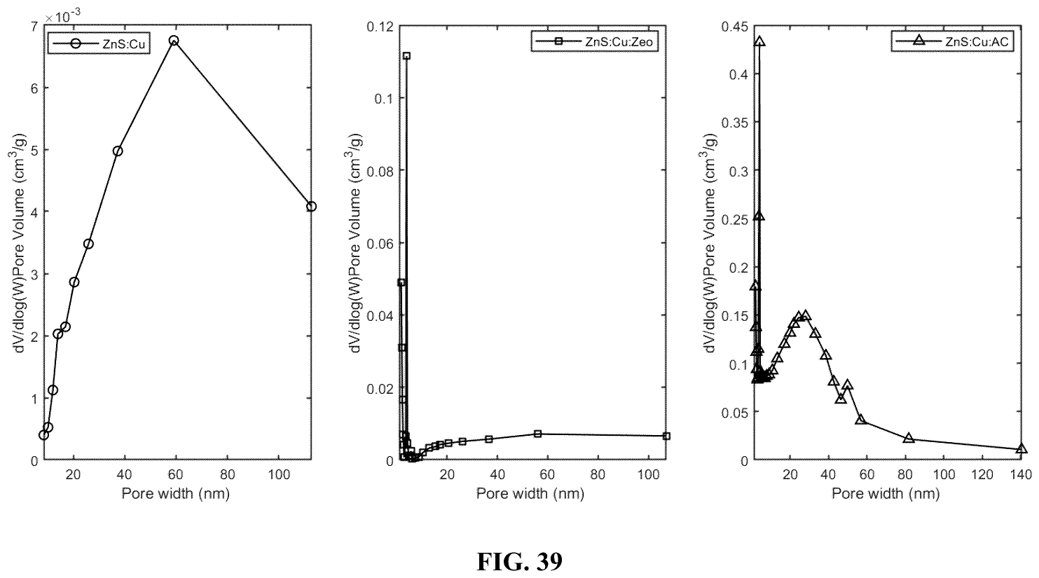

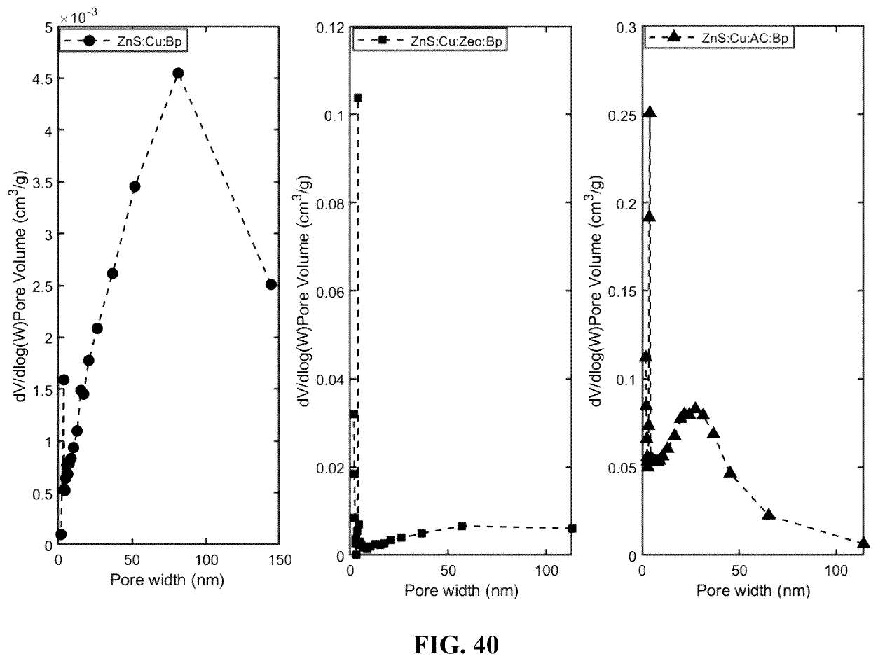

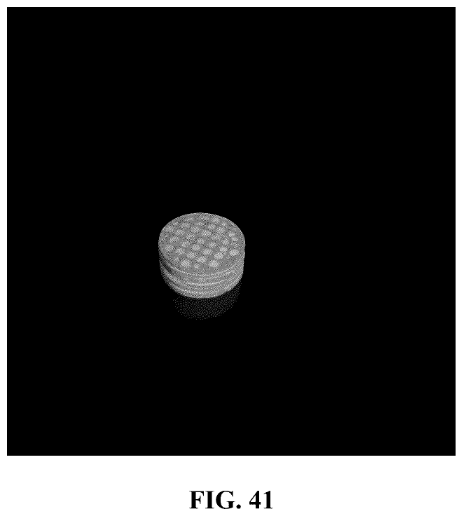

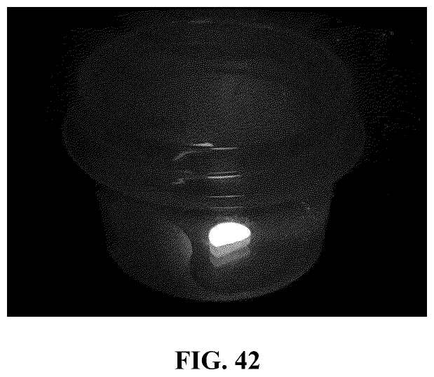

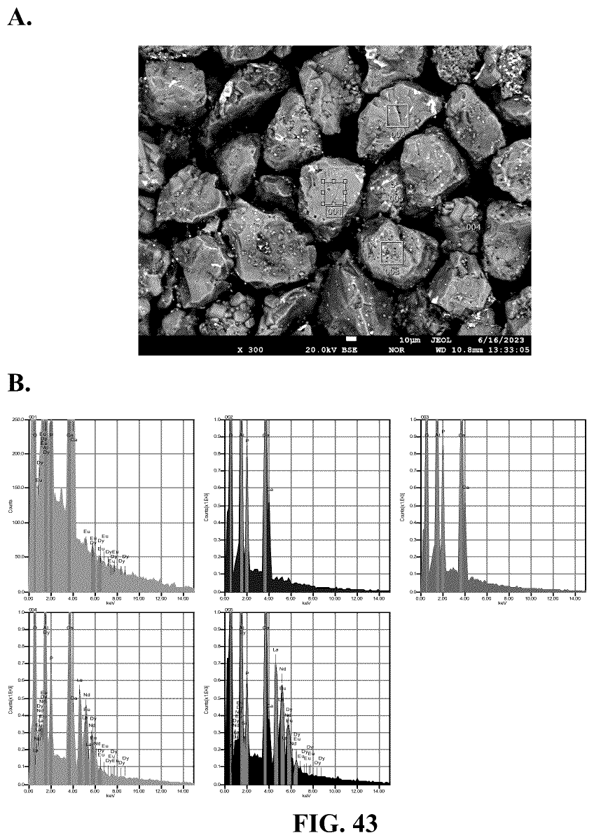

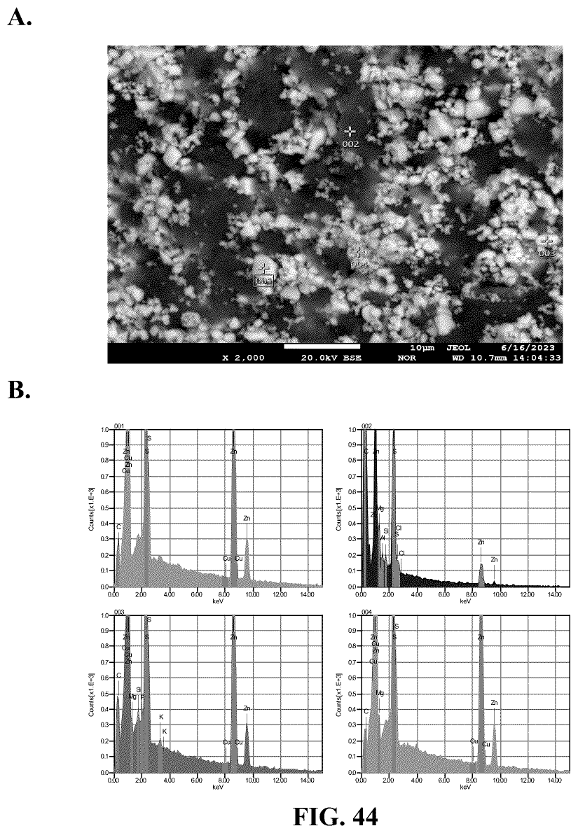

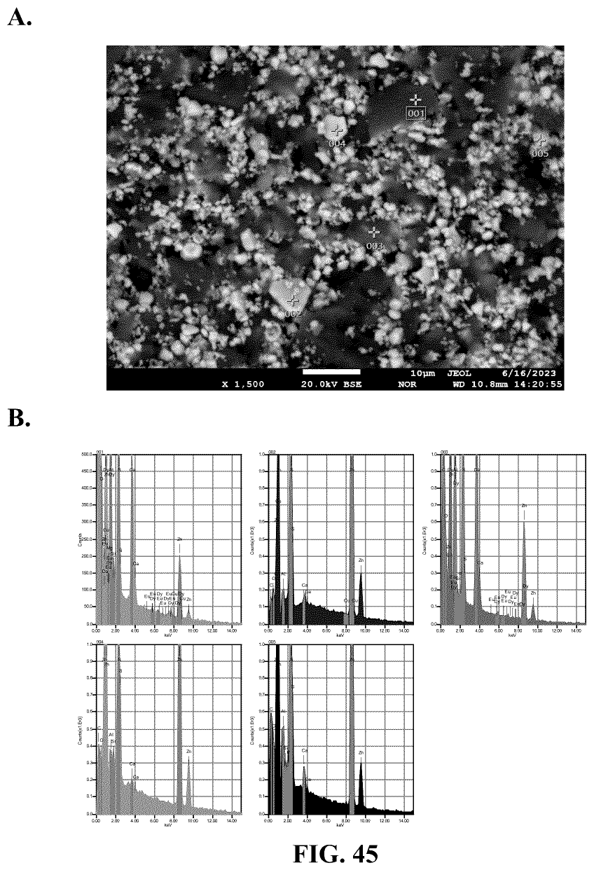

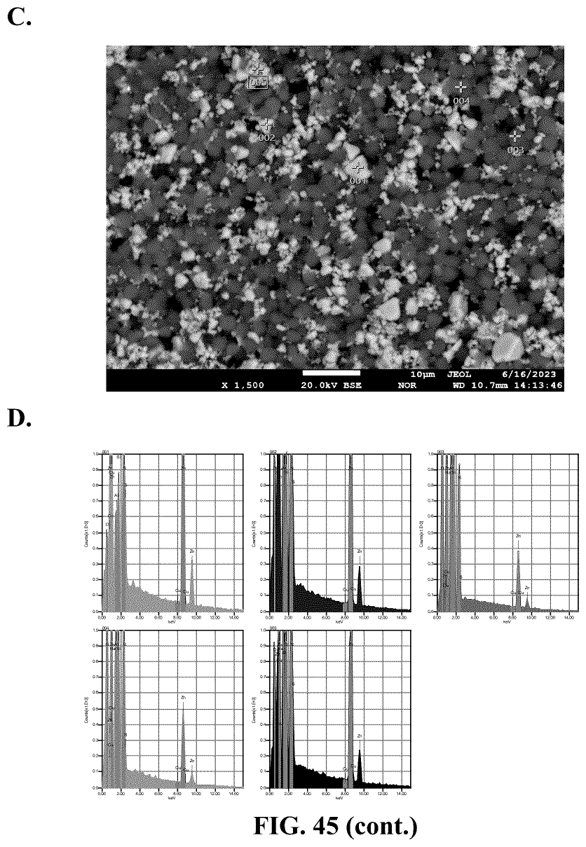

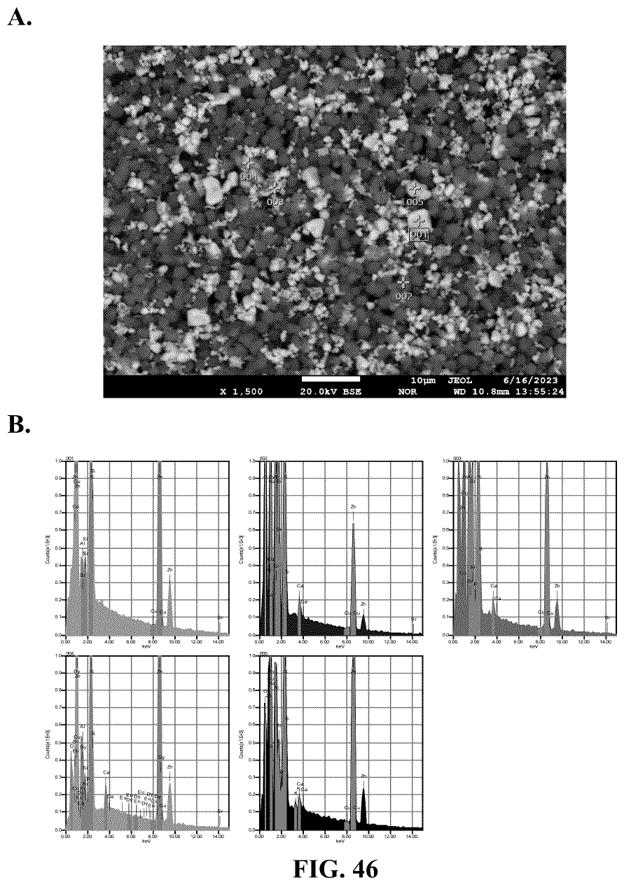

Isotherms presented in FIG. 21 show a drop in N₂ adsorption capacity for prints that had the phosphor incorporated within them; this is also consistent with the drop in BET surface area values reported in Table 2 for phosphor-based prints. Differential pore size distribution data highlighted in FIG. 39 and FIG. 40 indicate a transition in pore width ranges present in the print matrix upon introduction of adsorbent or phosphor into print matrix. As regards pore width variation, as indicated in Table 2, ZnS:Cu presents as the print with the highest average pore width, as its average desorption pore width value of 44.3 nm is only second to its phosphor counterpart (ZnS:Cu:Bp), which saw a drop in average pore width on account of introduction of the phosphor. A reduction in average pore width values is observed in all cases when adsorbent is introduced into the matrix and expressed in FIG. 39 by the distinct change in the differential volume curves showing an aggregation of pore widths in the <10 nm range.

### Results of UV Vis Absorption and Photoluminescence Tests

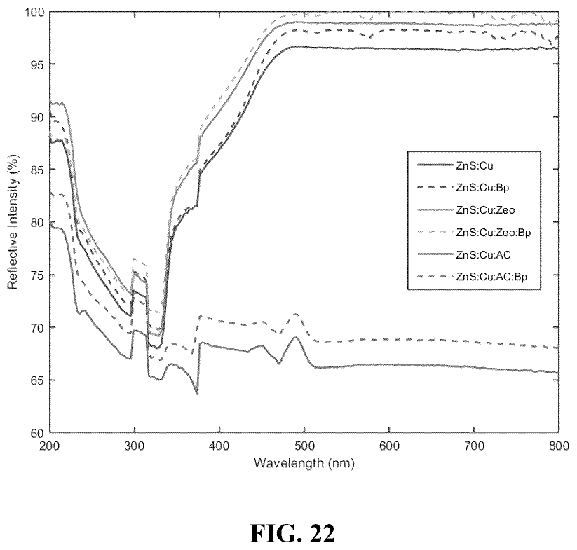

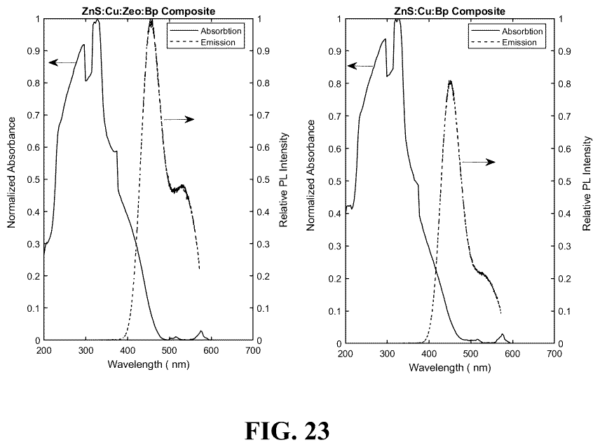

The influence of the introduction of adsorbents and phosphor into the ZnS:Cu matrix was investigated. FIG. 22 highlights the reflection data of the 6 printed structures and as mentioned earlier, absorbance information was subsequently obtained from this data set. Low reflectance values were obtained from ZnS:Cu:AC based prints because of their greyish coloration. However, their wavelength profile closely mirrors the behavior of the base ZnS:Cu prints and its Zeolite composites at relevant wavelength ranges. The introduction of either phosphor or adsorbent did not cause a drastic shift in light absorption wavelength range in the composite prints.

Additionally, based on the photoluminescence (PL) profile of the composite phosphor-based prints presented in FIG. 23 there is an intersection between the PL of the composite prints and the light absorption profile of the composite. This intersection is crucial given that the objective is to produce utilizable light generated by the monolith to extend a desired photocatalytic reaction. The afterglow of the ZnS:Cu:AC:Bp prints gave off faint PL signal.

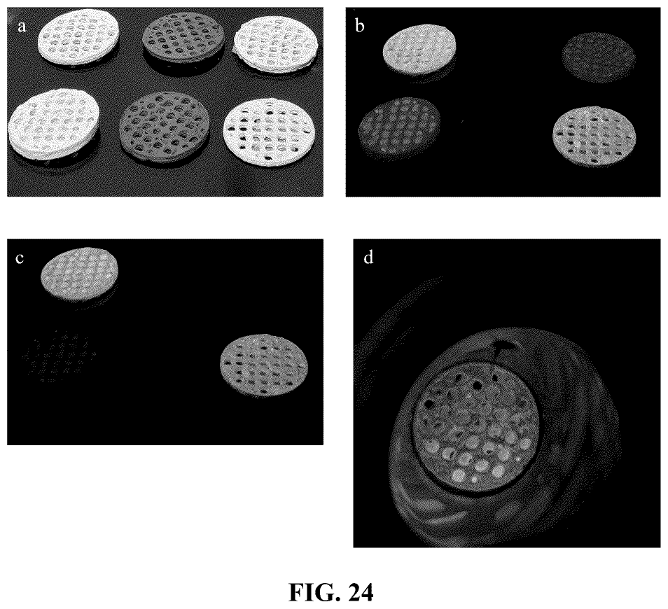

Subsequently, the PL time decays of the printed samples were analyzed to ascertain the decay times of the obtained afterglows. Typical representative examples of print appearance under ambient lighting are presented in FIGS. 24a-d; typical greyish coloration is exhibited by the activated carbon-based print. Post excitation by the LED lamp source, a visible glow was evident in the printed structures based on their material composition and whether or not they had the SrAlO₄:Eu:Dy (Bp) phosphor incorporated in their matrix. Post light excitation, structures with the phosphor incorporated in them showed a typical bluish glow, with the exception of the ZnS:Cu:AC:Bp print whose glow was suppressed by the dark coloration of the activated carbon adsorbent. ZnS:Cu based prints with no phosphor (i.e. ZnS:Cu:Zeo, ZnS:Cu:AC, and ZnSCu) showed a quickly fading greenish glow, with the exception of the ZnS:Cu:AC print that remained undetectable in the dark immediately after the light source terminated. Two minutes post termination of light source, structures without the blue phosphor incorporated had no visible glow, as indicated by FIG. 24c. Note that circles are imprinted into the images in FIG. 24a-c to allow for an indication of the position of the non-visible prints. Additionally, prints produced fit appropriately in the reactor; a typical example is highlighted in FIG. 24d.

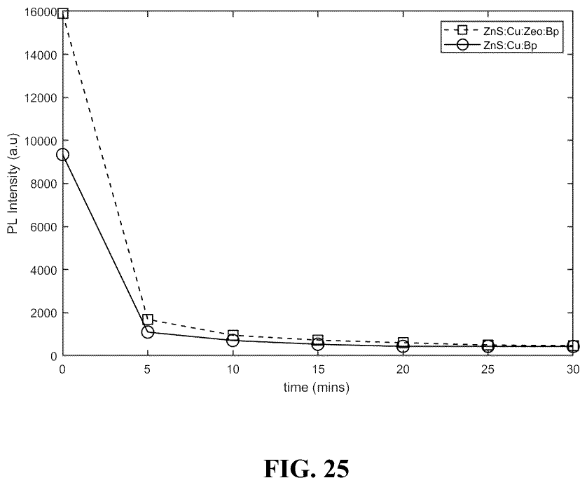

Time decay data for the ZnS:Cu:Bp and ZnS:Cu:Zeo:Bp prints is presented in FIG. 25. (The time decay data for ZnS:Cu and its adsorbent variants were not considered due to either non luminosity or very short decay times as confirmed in FIG. 24a-c). A rapid initial decay was observed in the first five minutes followed by a slow but more steady intensity burnout. The afterglow intensity of the ZnS:Cu:Zeo:Bp significantly supersedes that of ZnS:Cu:Bp, and both aforementioned composites dwarf the luminescence shown by ZnS:Cu:Ac:Bp which gives off a very faint signal when tested. Without wishing to be bound by theory, the disparity in intensity between ZnS:Cu:Zeo:Bp and ZnS:Cu:Bp can be due to the excess ZnS:Cu used in the latter (2:1-catalyst:phosphor ratio) suppresses the PL effect.

### Results of Photocatalytic Experiments

### Background Results

Background tests that were conducted to ascertain reactor airtightness and losses to the walls revealed no loss in H₂S concentration as the gas flowed through the inlet stainless steel lines, through the borosilicate reactor, and ultimately to the gas sensor. Additionally, no H₂S destruction/conversion was observed when the LED lamps were turned on while gas flowed through the reactor system. Lastly the SrAlO₄:Eu:Dy phosphor itself did not show any H₂S destruction when tested under H₂S gas flow under the action of light.

### Dark Adsorption Results

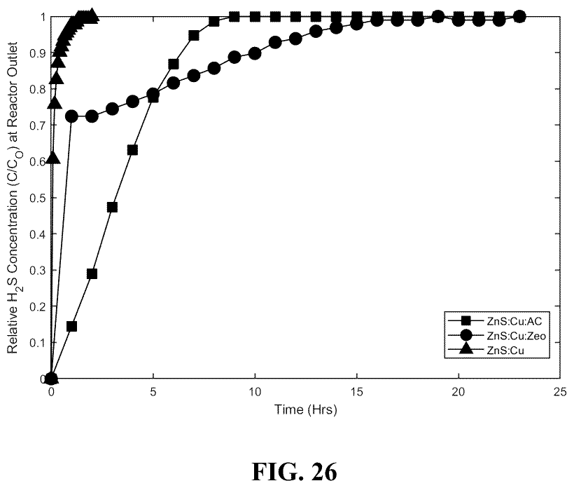

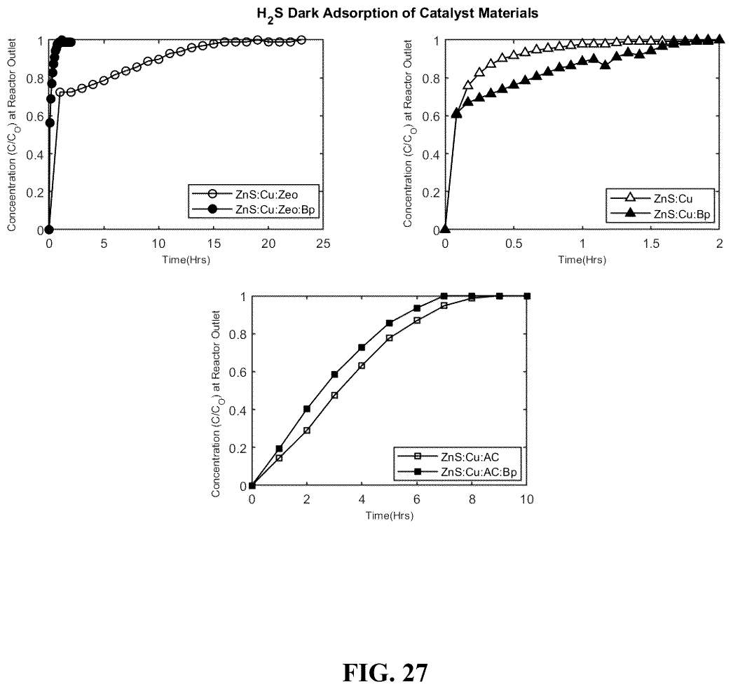

The dark adsorption performance of the printed monoliths was assessed and the results are presented in FIG. 26 and FIG. 27. Introduction of the zeolite and activated carbon adsorbents into the ZnS:Cu matrix led to vastly extended breakthrough curves with ZnS:Cu:Zeo breaking through fully after ˜15 hrs of dark adsorption, as highlighted in FIG. 26. The observed dark adsorption behavior of the adsorbent variations of ZnS:Cu is also supported by BET data summarized in Table 2, which showed improved surface area due to adsorbent introduction. Subsequently, comparisons are made between the dark adsorption profile of the catalyst materials containing SrAlO₄:Eu:Dy phosphor and those without the afterglow phosphor. Significant difference in time to breakthrough was observed for the Zeolite based composite and its phosphor counterpart on the order of about ˜10 hours more for breakthrough to occur. However, other phosphor based printed structures attained relatively similar breakthrough times as compared to their non phosphor counterparts, as indicated in FIG. 27.

### Long Term Destruction Results

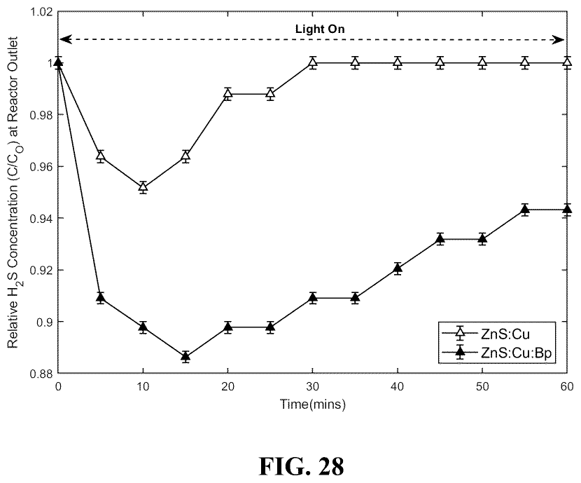

For the long-term destruction study, the destruction of H₂S over both ZnS:Cu and its phosphor counterpart (ZnS:Cu:Bp) were compared and is illustrated in FIG. 28. Error bars indicate in FIG. 28 and subsequent figures represent the standard deviation obtained from 2 to 3 repeat experiments. The ZnS:Cu print is typified by low H₂S conversion (˜5%) for the same time frame of illumination as the ZnS:Cu:Bp print, which showed peak conversion of ˜12%. Furthermore, the activity of the ZnS:Cu print terminates abruptly just after 30 minutes (breakthrough reached); however, the phosphor incorporated print enjoys sustained conversion. Low mass loadings with an example being a ZnS:Cu print of 1.5 g, no noticeable H₂S conversion was observed when said print was tested, prompting the increase in mass reflected in Table 1.

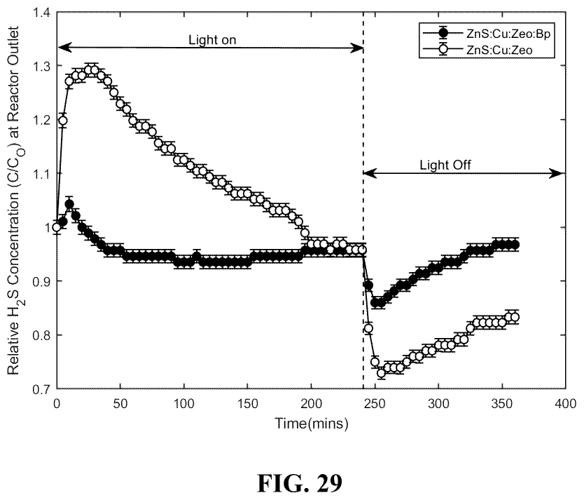

The mass of ZnS:Cu catalyst used in both the ZnS:Cu and ZnS:Cu:Bp samples was equivalent, and the only difference in both prints is the addition of the SrAlO₄:Eu:Dy phosphor. ZnS:Cu:Zeo:Bp as highlighted in FIG. 29 originally appears to not show a strong H₂S conversion behavior in comparison to its ZnS:Cu:Bp counterpart. However, noting that it only had half the amount of active catalyst present in its formulation as compared ZnS:Cu:Bp, and highlighted in Table 1 this reduction in performance is expected. Noteworthy for ZnS:Cu:Zeo:Bp as highlighted in FIG. 29 is the sustained conversion it exhibits over an extended period of time as against the reduction in conversion exhibited by ZnS:Cu:Bp. Without wishing to be bound by theory, this improved conversion for the two samples discussed is induced delayed hole recombination effects due to the intrinsic charge trapping mechanism of the phosphor in the matrix and additionally the improved surface area achieved by the incorporation of Zeolite as confirmed by BET analysis.

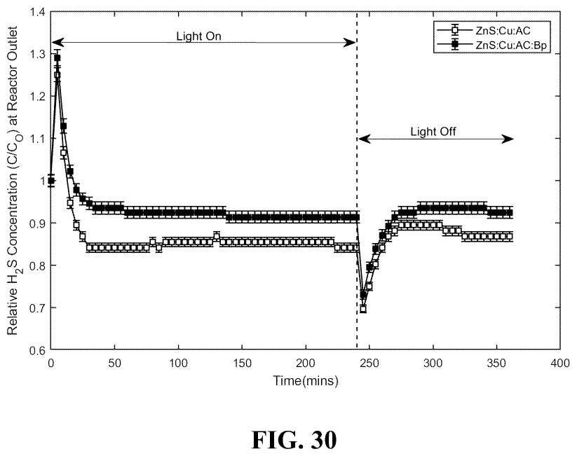

Additionally, noteworthy are the results obtained when the adsorbent based variations of ZnS:Cu (ZnSCu:AC and ZnSCu:Zeo) are both tested for long term destruction. From FIG. 29 and FIG. 30, for both the zeolite and activated carbon based ZnS:Cu, we see an initial rise of concentration in H₂S beyond the relative concentration value of 1, and a subsequent slow drop in said concentration, followed by a rapid fall in concentration at the onset of “light off”. The initial rise in concentration beyond the expected maximum H₂S concentration in both cases can be explained by the extended duration required to attain breakthrough in the case of the ZnS:Cu:AC and ZnS:Cu:Zeo as discussed in the dark adsorption portion of the results presented.

The accumulated H₂S molecules adsorbed on the catalyst surface are dispelled by the action of light and thus lead to the noted increase in concentration beyond the peak bypass value. This behavior is also noted in literature and hence not an experimental anomaly [45]. Subsequently there is a steady drop in concentration in both adsorbent cases after the peak bypass value has been attained and then a further rapid drop in concentration upon turning off the light source. The magnitude of the immediate rapid drop in concentration when the light source is turned off is always less than the initial peak rise in concentration which is ascribed to initial H₂S desorption by action of light. Without wishing to be bound by theory, the termination of the light source allows the monolith to rapidly begin re-adsorbing H₂S that was desorbed by light action, hence leading to the reduction in outlet concentration of H₂S.

The rapid rise-drop behavior is not observed in the ZnSCu:Zeo:Bp catalyst presented in FIG. 29 due to the shorter time to breakthrough. Rapid breakthrough is attained for this catalyst as highlighted in FIG. 27 in the dark adsorption study portion of this work. The quicker time to breakthrough means that less H₂S adsorbed unto the surface of the print; hence upon action of light, the typical rapid desorption leading to an increase in H₂S concentration at the outlet of the reactor was not observed. This is true for ZnS:Cu and ZnS:Cu:Bp as well, which show rapid breakthrough times as can be confirmed in FIG. 27. The rise-drop behavior is also in the phosphor incorporated version of ZnS:Cu:AC due to its extended breakthrough time, although no improvement in conversion is noticed as highlighted in FIG. 30.

### Cyclic Tests

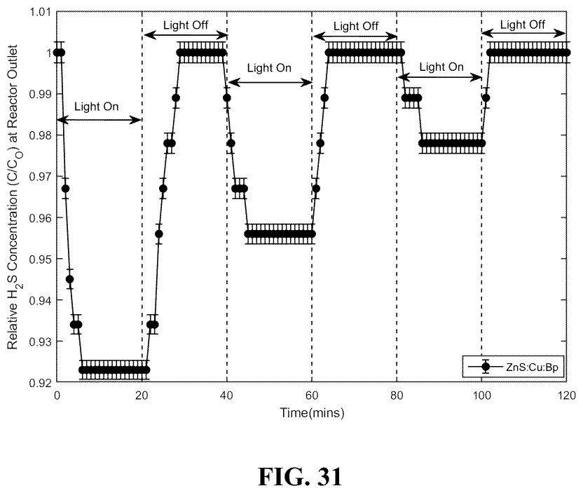

Typical afterglow response of the printed ZnS:Cu:Bp is highlighted in FIG. 29. Although sustainable cyclic behavior is shown in FIG. 31, the sustained afterglow H₂S conversion of ZnS:Cu:Bp is not apparent. Additionally, continuous cycling of the base ZnS:Cu was not practical due to minimal conversion levels (as shown in FIG. 28) and rapid deactivation. Very weak afterglow is detected for the phosphor-based print that had activated carbon (Zns:Cu:AC:Bp) incorporated within it. As indicated earlier, activated carbon powder presents as a dark material with relatively lower density as compared to the SrAlO₄:Eu:Dy phosphor and hence the activated carbon volume in the matrix strongly overpowers the phosphor and masks the afterglow.

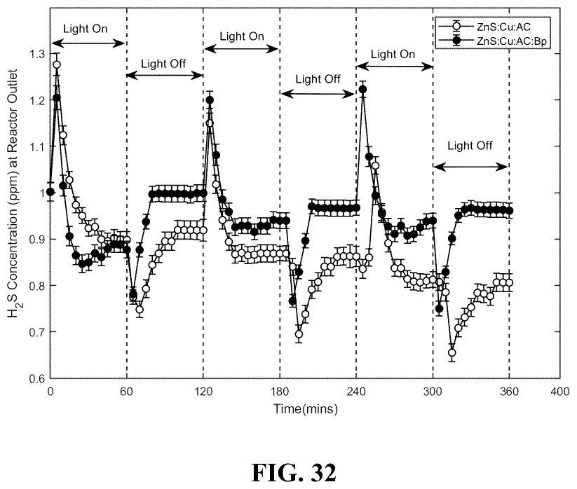

The Zns:Cu:AC:Bp print's afterglow response during cyclic tests as depicted in FIG. 32 did not also show extended conversion in the absence of an external light source and closely mirrors the behavior of its phosphor-less counterpart. It is concluded that due to its non-evident glow and greyish coloration, the afterglow effect of the printed monolith on H₂S is strongly inhibited. The weak afterglow of ZnS:Cu:AC:Bp has been observed in FIG. 24a-d and this option was explored only for the sake of experimental completeness.

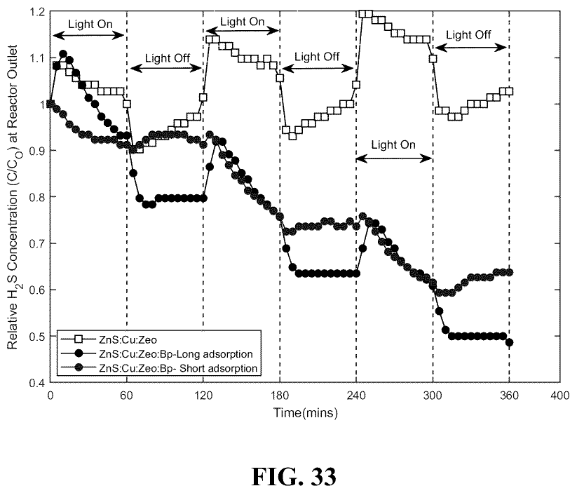

As depicted in FIG. 33, ZnS:Cu:Zeo:Bp showed sustained afterglow conversion of H₂S as compared to its base counterpart. The ZnS:Cu:Zeo:Bp monolith's H₂S conversion ability was cyclically tested after an extended period of adsorption matching the adsorption period of ZnS:Cu:Zeo. Additionally, ZnS:Cu:Zeo:Bp was also tested for a much shorter period matching its original break-through time (see FIG. 27). This disparity in adsorption times was employed to further validate that indeed the “rise-drop” behavior as observed and discussed for the zeolite and activated carbon samples was only a response to extended adsorption and subsequent desorption by action of light. For the extended adsorption mode testing of ZnS:Cu:Zeo:Bp, results obtained in FIG. 33 illustrate the rise-drop behavior as observed in prints with relatively long breakthrough times. When ZnS:Cu:Zeo:Bp was tested after a shorter period of adsorption exposure, it no longer showed the rise-drop behavior as predicted. In both modes of ZnS:Cu:Zeo:Bp monolith testing, there was a synergistic cooperation between the zeolite and the embedded SrAl204 phosphor, thereby leading to the observed sustained conversion.

### Conclusions

Described herein are the first direct ink written dual functional luminous monolithic structures applied to H₂S photocatalysis. The incorporation of the phosphor results in intrinsic luminosity to activate the photocatalyst, thereby providing a shift from traditional reactor configurations that have been employed in literature, not just for H₂S photocatalysis but other photocatalytic applications as well. Besides showing that H₂S photocatalysis is feasible with DIW structures we also show that the sustained H₂S conversion by action of the afterglow response of an appropriate phosphor in the absence of a traditional light source. It was shown that a ZnSCu:Zeo:Bp based print can extend H₂S conversion by synergistic action of the SrAlO₄:Eu:Dy phosphor and the zeolite adsorbent., For example the adsorbent xeolite and the phosphor can trap charges and exhibit delayed hole recombination effect.

### REFERENCES

[1] M. J. Regufe, A. F. Ferreira, J. M. Loureiro, A. Rodrigues, A. M. Ribeiro, Electrical conductive 3D-printed monolith adsorbent for CO₂ capture, Microporous and Mesoporous Materials 278 (2019) 403-413.
[2] V. Middelkoop, K. Coenen, J. Schalck, M. V. S. Annaland, F. Gallucci, 3D printed versus spherical adsorbents for gas sweetening, Chemical Engineering Journal 357 (2019) 309-319.
[3] V. Middelkoop, A. Vamvakeros, D. De Wit, S. D. Jacques, S. Danaci, C. Jacquot, Y. De Vos, D. Matras, S. W. Price, A. M. Beale, 3D printed Ni/Al2O3 based catalysts for CO2 methanation-a comparative and operando XRD-CT study, Journal of CO2 Utilization 33 (2019) 478-487.
[4] S. Lawson, K. Baamran, K. Newport, T. Alghamadi, G. Jacobs, F. Rezaci, A. A. Rownaghi, Integrated Direct Air Capture and Oxidative Dehydrogenation of Propane with CO₂ at Isothermal Conditions, Applied Catalysis B: Environmental (2021) 120907.
[5] V. Tomašić, F. Jović, State-of-the-art in the monolithic catalysts/reactors, Applied Catalysis A: General 311 (2006) 112-121.
[6] S. Govender, H. B. Friedrich, Monoliths: A Review of the Basics, Preparation Methods and Their Relevance to Oxidation, Catalysts 7 (2017) 62. https://doi.org/10.3390/catal7020062.
[7] A. Cybulski, J. A. Moulijn, Monoliths in Heterogeneous Catalysis, Catalysis Reviews 36 (1994) 179-270. https://doi.org/10.1080/01614949408013925.
[8] H. Lin, K. T. Valsaraj, Development of an optical fiber monolith reactor for photocatalytic wastewater Treatment, J Appl Electrochem 35 (2005) 699-708. https://doi.org/10.1007/s10800-005-1364-x.
[9] K.-P. Yu, G. W.-M. Lec, A.-J. Hung, Removal of indoor a-pinene with a fiber optic illuminated honeycomb monolith photocatalytic reactor, Journal of Environmental Science and Health, Part A 49 (2014) 1110-1115. https://doi.org/10.1080/10934529.2014.897146.
[10] T. Wang, L. Yang, X. Du, Y. Yang, Numerical investigation on CO₂ photocatalytic reduction in optical fiber monolith reactor, Energy Conversion and Management 65 (2013) 299-307. https://doi.org/10.1016/j.enconman.2012.08.021.
[11] H. Chen, F. Chu, L. Yang, O. Ola, X. Du, Y. Yang, Enhanced photocatalytic reduction of carbon dioxide in optical fiber monolith reactor with transparent glass balls, Applied Energy 230 (2018) 1403-1413. https://doi.org/10.1016/j.apenergy.2018.09.081.
[12] P. Du, J. T. Carneiro, J. A. Moulijn, G. Mul, A novel photocatalytic monolith reactor for multiphase heterogeneous photocatalysis, Applied Catalysis A: General 334 (2008) 119-128. https://doi.org/10.1016/j.apcata.2007.09.045.
[13] D. Bidwai, N. K. Sahu, S. J. Dhoble, A. Mahajan, D. Haranath, G. Swati, Review on long afterglow nanophosphors, their mechanism and its application in round-the-clock working photocatalysis, Methods and Applications in Fluorescence 10 (2022) 032001.
[14] S. Shionoya, W. M. Yen, H. Yamamoto, Phosphor Handbook, CRC Press, 2018.
[15] C. Zhou, P. Zhan, J. Zhao, X. Tang, W. Liu, M. Jin, X. Wang, Long-lasting CaAl2O4: Eu2+, Nd3+ phosphor-coupled g-C3N4 QDs composites for the round-the-clock photocatalytic methyl orange degradation, Ceramics International 46 (2020) 27884-27891.
[16] V. Havasi, B. Vödrédi, Á. Kukovecz, Photocatalytic performance of Sr4Al14O25: Eu, Dy phosphor assisted ZnO: Co+Ag nanocomposite under continuous and pulsed illumination, Catalysis Today 284 (2017) 107-113.
[17] Y. Xiong, J. Zhao, Z. Zheng, F. Yi, X. Tang, D. Jin, M. Jin, CaAl 2 O 4: Eu 2+, Nd 3+-coupled gC 3 N 4 composites as novel light-free photocatalyst for organic methyl orange (MO) degradation, Journal of Materials Science: Materials in Electronics 32 (2021) 7271-7284.
[18] X. Liu, X. Chen, Y. Li, B. Wu, X. Luo, S. Ouyang, S. Luo, A. A. Al Kheraif, J. Lin, A gC 3 N 4@ Au@ SrAl 2 O 4: Eu 2+, Dy 3+ composite as an efficient plasmonic photocatalyst for round-the-clock environmental purification and hydrogen evolution, Journal of Materials Chemistry A 7 (2019) 19173-19186.
[19] Q. Zhou, F. Peng, Y. Ni, J. Kou, C. Lu, Z. Xu, Long afterglow phosphor driven round-the-clock g-C3N4 photocatalyst, Journal of Photochemistry and Photobiology A: Chemistry 328 (2016) 182-188.
[20] J. Tang, X. Liu, Y. Liu, X. Zhang, Y. Lin, L. Chen, D. Fang, J. Wang, Novel Z-scheme Sr2MgSi2O7: Eu2+, Dy3+/Ag3PO4 photocatalyst for round-the-clock efficient degradation of organic pollutants and hydrogen production, Chemical Engineering Journal 435 (2022) 134773.
[21] I. S. Omodolor, H. O. Otor, J. A. Andonegui, B. J. Allen, A. C. Alba-Rubio, Dual-Function Materials for CO2 Capture and Conversion: A Review, Ind. Eng. Chem. Res. 59 (2020) 17612-17631. https://doi.org/10.1021/acs.iecr.0c02218.
[22] N. Yahya, F. Aziz, N. A. Jamaludin, M. A. Mutalib, A. F. Ismail, W. N. W. Salleh, J. Jaafar, N. Yusof, N. A. Ludin, A review of integrated photocatalyst adsorbents for wastewater treatment, Journal of Environmental Chemical Engineering 6 (2018) 7411-7425. https://doi.org/10.1016/j.jecc.2018.06.051.
[23] M. Usman, O. Monfort, S. Gowrisankaran, B. H. Hameed, K. Hanna, M. Al-Abri, Dual functional materials capable of integrating adsorption and Fenton-based oxidation processes for highly efficient removal of pharmaceutical contaminants, Journal of Water Process Engineering 52 (2023) 103566. https://doi.org/10.1016/j.jwpc.2023.103566.
[24] D. Keane, S. Basha, K. Nolan, A. Morrissey, M. Oelgemöller, J. M. Tobin, Photodegradation of Famotidine by Integrated Photocatalytic Adsorbent (IPCA) and Kinetic Study, Catal Lett 141 (2011) 300-308. https://doi.org/10.1007/s10562-010-0485-y.
[25] S. Lawson, K. Baamran, K. Newport, F. Rezaci, A. A. Rownaghi, Formulation and processing of dual functional Adsorbent/Catalyst structured monoliths using an additively manufactured contactor for direct Capture/Conversion of CO₂ with cogeneration of ethylene, Chemical Engineering Journal (2021) 133224. https://doi.org/10.1016/j.cej.2021.133224.
[26] S. Lawson, K. Baamran, K. Newport, T. Alghamadi, G. Jacobs, F. Rezaci, A. A. Rownaghi, Integrated direct air capture and oxidative dehydrogenation of propane with CO₂ at isothermal conditions, Applied Catalysis B: Environmental 303 (2022) 120907. https://doi.org/10.1016/j.apcatb.2021.120907.
[27] M. A. Ávila-López, T. E. Lara-Ceniceros, F. E. Longoria, A. A. Elguezabal, A. Martínez De La Cruz, M. A. Garza-Navarro, J. Bonilla-Cruz, Photodegradation of Air and Water Contaminants Using 3D-Printed TiO 2 Nanoparticle Scaffolds, ACS Appl. Nano Mater. 5 (2022) 11437-11446. https://doi.org/10.1021/acsanm.2c02498.
[28] C. Li, Y. Zhang, C. Qiu, B. Yuan, R. Zhang, W. Li, H. Jin, Powder-precursor integrated 3D-printed TiO2 photocatalyst and adsorption-degradation synergy effect, Colloids and Surfaces A: Physicochemical and Engineering Aspects 671 (2023) 131570. https://doi.org/10.1016/j.colsurfa.2023.131570.
[29] H. Oladipo, A. Yusuf, S. Al Jitan, G. Palmisano, Overview and challenges of the photolytic and photocatalytic splitting of H₂S, Catalysis Today (2021).
[30] M. Dan, A. Prakash, Q. Cai, J. Xiang, Y. Ye, Y. Li, S. Yu, Y. Lin, Y. Zhou, Energy-Band-Controlling Strategy to Construct Novel CdxIn1-xS Solid Solution for Durable Visible Light Photocatalytic Hydrogen Sulfide Splitting, Solar RRL 3 (2019) 1800237.
[31] M. Dan, S. Wei, D. E. Doronkin, Y. Li, Z. Zhao, S. Yu, J.-D. Grunwaldt, Y. Lin, Y. Zhou, Novel MnS/(InxCu1-x) 2S3 composite for robust solar hydrogen sulphide splitting via the synergy of solid solution and heterojunction, Applied Catalysis B: Environmental 243 (2019) 790-800.
[32] M. Dan, Q. Zhang, S. Yu, A. Prakash, Y. Lin, Y. Zhou, Noble-metal-free MnS/In2S3 composite as highly efficient visible light driven photocatalyst for H2 production from H₂S, Applied Catalysis B: Environmental 217 (2017) 530-539.
[33] M. Dan, S. Yu, Y. Li, S. Wei, J. Xiang, Y. Zhou, Hydrogen sulfide conversion: How to capture hydrogen and sulfur by photocatalysis, Journal of Photochemistry and Photobiology C: Photochemistry Reviews 42 (2020) 100339. https://doi.org/10.1016/j.jphotochemrev.2019.100339.
[34] S. A. Naman, Comparison between thermal decomposition and photosplitting of H2S over VxSy supported on oxides at 450-550 C in a static system, International Journal of Hydrogen Energy 17 (1992) 499-504.
[35] M. A. Guijun, Y. A. N. Hongjian, Z. Xu, M. A. Baojun, H. Jiang, W. E. N. Fuyu, L. I. Can, Photocatalytic splitting of H2S to produce hydrogen by gas-solid phase reaction, Chinese Journal of Catalysis 29 (2008) 313-315.
[36] V. Precthi, S. Kanmani, Optimization of operating parameters for gas-phase photocatalytic splitting of H2S by novel vermiculate packed tubular reactor, Journal of Environmental Management 181 (2016) 674-680.
[37] V. Precthi, S. Kanmani, Performance of gas-phase photocatalytic reactors on hydrogen production, International Journal of Hydrogen Energy 42 (2017) 8997-9002.
[38] H. G. Baldovi, J. Albero, B. Ferrer, D. Mateo, M. Alvaro, H. García, Gas-Phase Photochemical Overall H2S Splitting by UV Light Irradiation, ChemSusChem 10 (2017) 1996-2000. https://doi.org/10.1002/cssc.201700294.
[39] R. Chauhan, A. Kumar, R. P. Chaudhary, Photocatalytic degradation of methylene blue with Cu doped ZnS nanoparticles, Journal of Luminescence 145 (2014) 6-12.
[40] M. Dong, P. Zhou, C. Jiang, B. Cheng, J. Yu, First-principles investigation of Cu-doped ZnS with enhanced photocatalytic hydrogen production activity, Chemical Physics Letters 668 (2017) 1-6.
[41] G.-J. Lec, S. Anandan, S. J. Masten, J. J. Wu, Photocatalytic hydrogen evolution from water splitting using Cu doped ZnS microspheres under visible light irradiation, Renewable Energy 89 (2016) 18-26.
[42] W. Luo, J. Ying, S. Yu, X. Yang, Y. Jia, M. Chen, H. Zhang, J. Gao, Y. Li, Y.-W. Mai, ZnS:Cu powders with strong visible-light photocatalysis and pyro-catalysis for room-temperature dye decomposition, Ceramics International 46 (2020) 12096-12101.
[43] X. Liu, Y. Zhang, S. Matsushima, T. Sugiyama, H. Hojo, H. Einaga, Rational design of Cu-Doped ZnS nanospheres for photocatalytic evolution of H2 with visible light, ACS Applied Energy Materials 5 (2022) 1849-1857.
[44] A. Abdullahi, M. Lamansky, L. C. Williams-Godwin, J. M. Andino, Direct ink written ZnS:Cu photocatalytic luminous monoliths, Optical Materials 147 (2024) 114748.
[45] T.-D. Pham, B.-K. Lee, C.-H. Lee, The advanced removal of benzene from aerosols by photocatalytic oxidation and adsorption of Cu—TiO2/PU under visible light irradiation, Applied Catalysis B: Environmental 182 (2016) 172-183. https://doi.org/10.1016/j.apcatb.2015.09.023.

See also, U.S. Pat. No. 11,298,675.

### Rheology Results

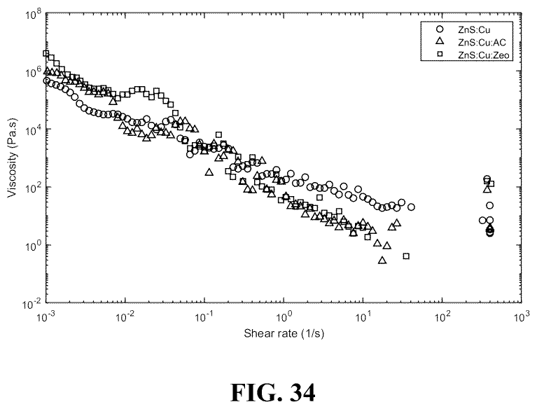

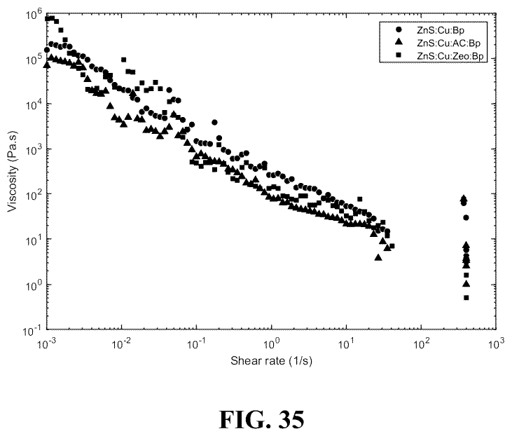

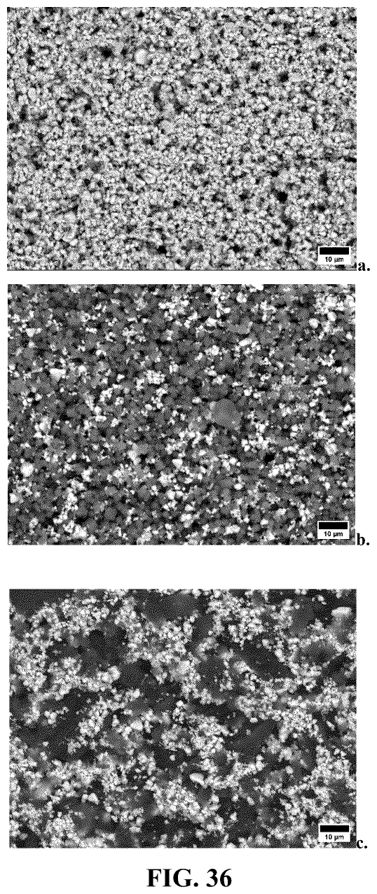

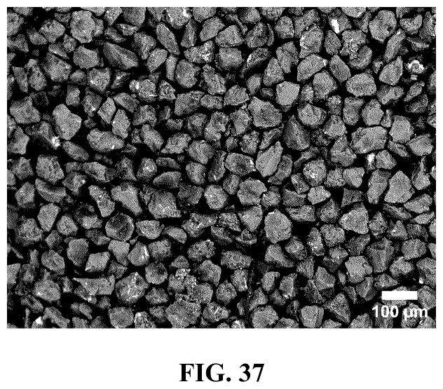

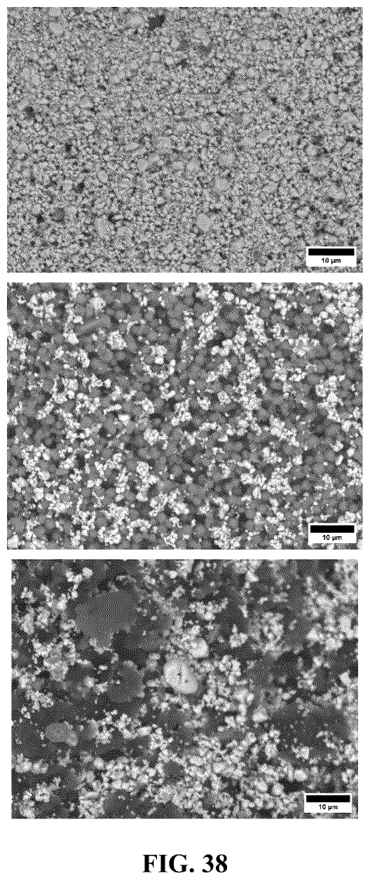

Non-limiting, exemplary results from the rheological tests conducted are presented in FIG. 34 and FIG. 35 and represents the set of inks without the afterglow phosphor incorporated within and the set with the phosphor incorporated, respectively. For the range of shear rate values tested, pseudoplastic behaviors of the inks developed were observed at low to intermediate shear rate values (0.001-100 s⁻¹). A departure from pseudoplastic behavior is noted beyond shear rate value of 100 s⁻¹ even for ZnS:Cu which had no adsorbent or phosphor incorporated. The departure from viscoelasticity can be due to high shear rate values as against ink dry out. Inks were re-tested for a logarithmic shear rate 100-1000 s⁻¹ as indicated in FIG. 35, and random behavior at high shear rate values was still observed.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed is:

1. A composition comprising a photocatalyst, a phosphor, a solvent, and a binder,
wherein the phosphor comprises an emission profile wavelength that overlaps with the wavelength of the light absorption profile of the photocatalyst.

2. The composition of claim 1, wherein the composition is an additive manufacturing ink.

3. The composition of claim 1, wherein the composition is photoluminescent.

4. The composition of claim 1, wherein the composition comprises a photocatalyst to phosphor ratio of about 1:1 to about 10:1.

5. The composition of claim 1, wherein:
the photocatalyst is a visible light photocatalyst;
the phosphor is a long afterglow phosphor;
the binder is a plasticizing organic binder;
the solvent comprises H2O, an alcohol, or a combination thereof; or
any combination thereof.

6. The composition of claim 5, wherein:
the visible light photocatalyst is ZnS:Cu;
the long afterglow phosphor is SrAlO₄:Eu:Dy;
the plasticizing organic binder is methyl cellulose; or
any combination thereof.

7. The composition of claim 1, wherein the binder is present in about 2.5 wt. % to about 10.0 wt. %.

8. The composition of claim 1, wherein the wavelength comprises about 380 nm to about 700 nm.

9. The composition of claim 1, wherein the photocatalyst further comprises a sorbent material selective for a gas of interest.

10. The composition of claim 9, wherein the sorbent material is selected from a zeolite, activated carbon, a metal-organic framework, or a combination thereof.

11. A method of manufacturing a luminous monolithic structure, the method comprising:
depositing the composition of claim 1 into a geometry;
subjecting the deposited composition to drying, thereby producing a monolithic structure; and
exposing the monolithic structure to a sufficient initiation/excitation wavelength, thereby producing a luminous monolithic structure.

12. The method of claim 11, wherein the composition further comprises a sorbent, thereby producing a dual-function luminous monolithic structure.

13. The method of claim 11, wherein the sufficient initiation/excitation wavelength comprises about 380 nm to about 700 nm.

14. A luminous monolithic structure produced by the method of claim 11.

15. The structure of claim 14, wherein the structure comprises photoluminescence.

16. The structure of claim 14, wherein the photoluminescence is sufficient to initiate photocatalysis, sustain photocatalysis, or a combination thereof.

17. The structure of claim 14, wherein the structure exhibits uniform light distribution.

18. A method of performing gas-phase photocatalysis, the method comprising:
flowing a gas of interest over the surface of the monolithic structure of claim 14; and
exciting the monolithic structure with a visible light source under the gas flow, thereby performing gas-phase photocatalysis to decompose the gas of interest.

19. The method of claim 18, further comprising removing the light source, thereby producing an afterglow and performing gas-phase photocatalysis with the afterglow.

20. The method of claim 18, wherein the gas of interest comprises H2S and the decomposition of the gas of interest produces H2.
